(19) United States
(12) Patent Application Publication
(10) Pub. No.: US 2008/0257177 A1
(43) Pub. Date: Oct. 23, 2008

(54) High-Compression Baler

(76) Inventors: Irfan Toor, Plano, TX (US); F. Scott Crawford, Carrollton, TX (US); Rick R. Redie, Richardson, TX (US); Ritchie G. Studer, Plano, TX (US)

Correspondence Address: HEIMBECHER & ASSOC., LLC, P O BOX 33, HAMEL, MN, 55340-0033, US

(21) Appl. No.: 11/718,237

(22) PCT Filed: Jun. 12, 2006
(86) PCT No.: PCT/US06/22903

§ 371 Date: Jul. 3, 2007

Related U.S. Application Data
(60) Provisional application No. 60/689,411, filed on Jun. 10, 2005.

(51) Int. Cl. B30B 5/00

(52) U.S. Cl. 100/249

(57) ABSTRACT

High-compression balers and methods for forming bales are disclosed. An exemplary baler (10) comprises a baling chamber (26) configured to receive the material. The baling chamber is formed by a pair of end plates (30a, 30b) defining the longitudinal ends of the baling chamber, and a driven endless belt (28) guided by a plurality of rollers (36, 37, 40, 44, 50). The endless belt defines a periphery of the baling chamber. An exemplary method comprises providing an endless belt around at least a driven roller (40) and a tilt roller pair (36, 37), receiving the material in a baling chamber (26) through a throat (24) formed between the driven roller (40) and the tilt roller pair (36, 37), increasing the pressure applied by the endless belt (28) to the material, and securing the material in the baling chamber with netting (60) to form the bales (20).

### CROSS-REFERENCE TO RELATED APPLICATIONS

This application is related to U.S. provisional patent application No. 60/681,896, filed 16 May 2005. This application is also related to U.S. nonprovisional application Ser. No. 09/980,527, filed 29 Apr. 2002, which has been allowed. Each of these applications is hereby incorporated by reference as though fully set forth herein.

### BACKGROUND OF THE INVENTION

a. Field of the Invention

The instant invention relates to a bale press for baling a wide variety of materials and to a method of compressing a wide variety of materials into bales. In particular, the instant invention relates to bale presses and related methods for many cylindrical bales.

b. Background Art

It is well known that refuse may be compressed into bales, such as for transport, to burn for energy generation, or for disposal. Thus, the bales allow the refuse to be held together and to maintain its caloric value where the refuse is to be burned. In U.S. Pat. No. 6,336,306 (the '306 patent), for example, a round bale press or baler is disclosed including an endless belt guided around a plurality of deflection rollers via a pair of disk-like side walls or end plates defining a compression chamber. Refuse is fed into the compression chamber via a feed aperture and compacted into a round bale. A yarn or net web is unwound around a roller and into the compression chamber to pre-secure the compressed bale. The pre-secured bale may then be delivered to a wrapping apparatus to be fully enveloped in film, or the pre-secured bale may then be transported, burned, or otherwise disposed of as is. The endless belt comprises a segment pivotable out of a closed configuration suitable for compacting refuse to an open configuration suitable for discharging the pre-secured round bale from the compression chamber and conveying the bale to a wrapping table.

For some applications, the baling process is most cost-effective when the bales are, for example, efficiently and rapidly compacted to a high density. Where the bales are to be disposed of in a landfill, for example, it is valuable to maximize use of the available landfill volume by more tightly compacting each bale so as to increase the amount of refuse that can be stored in the same volume of the landfill. In addition, the less time it takes to produce each bale, the faster, more efficient, and cost-effective the waste disposal process becomes.

While round bale presses such as the one disclosed in the '306 patent provide round bales of compacted refuse that may be transported, burned, or otherwise disposed of, problems often arise when the bales are compacted at increased compression and/or higher speeds. Where the compression of the refuse in the compression chamber of a round bale press is increased, for example, refuse often “boils” at the feed aperture or “throat” of the compression chamber as the hard-packed bale in the compression chamber prevents the new refuse from entering the compression chamber. In addition, as bale compression increases in existing bale presses, the bale itself bulges out at the feed aperture of the compression chamber. Before desirable bale densities can be reached, the bulge can get large enough that the bale is prevented from easily rotating within the compression chamber, and the motors driving the endless belt may stall or fail prematurely. Merely increasing the size or horsepower of the drive motor or motors may not overcome this stalling tendency and may unnecessarily increase the size and/or cost of the bale press.

Where the production speed of the bale press is increased, other problems are often created. For example, until enough refuse is in the compression chamber, the refuse rolls or tumbles around the chamber similar to clothing in a dryer without being compressed. Thus, wasted time and energy is used operating the bale press until the chamber is sufficiently full so that the refuse starts to be compacted. In addition, as the speed of the bale press is increased, the tendency of the yarn or net web to skew to one end of the roller may increase. A skewed web may, for example, insufficiently secure the bale so that as the bale exits the bale press, the bale falls apart and the bale press must be stopped to clean up the refuse that has separated from the bale. The skewed web may also catch on a portion of the compression chamber and jam the bale press. Again, the bale press must be stopped to clear the jam and realign the web. Time lost cleaning a busted bale from the bale press and realigning the web is time that could have been used to form more bales.

Further, as the pivotable segment of the endless belt opens, the kinetic energy of the bale may cause unloading problems if the bale is allowed to roll out of the compression chamber of the bale press.

Thus, it remains desirable to have a bale press that operates at high speed while creating high-density bales that may be efficiently unloaded from the bale press.

### BRIEF SUMMARY OF THE INVENTION

It is desirable to be able to have a high-speed baler capable of reliably producing high-density bales.

The foregoing and other aspects, features, details, utilities, and advantages of the present invention will be apparent from reading the following description and claims, and from reviewing the accompanying drawings.

### BRIEF DESCRIPTION OF THE DRAWINGS

FIG. 1 is an isometric view of the front and right side of a baler according to a first embodiment of the present invention, shown with a baler tailgate in a fully-open configuration.

FIG. 2 is an isometric view of the front and left side of the baler depicted in FIG. 1 with various components removed for clarity and clearly showing a tilt roller pair adjacent to a distal edge of the tailgate, the tilt roller pair including a distal tilt roller and a proximal tilt roller.

FIG. 3 is a schematic left side view of the baler depicted in FIGS. 1 and 2 during the initial phase of bale formation, and depicts a first embodiment for a securement netting delivery system.

FIG. 4 is similar to FIG. 3, but depicts the baler of FIGS. 1-3 during an intermediate phase of the compression cycle.

FIG. 5 is similar to FIG. 4, depicting the baler of FIGS. 1-4 during a later intermediate phase of a baler cycle, with the tilt roller pair adjacent to the distal edge of the tailgate rotated slightly inward toward the bale being formed.

FIG. 6 is similar to FIGS. 3-5, but depicts the tilt roller pair along the distal edge in the tailgate rotated to its maximum inward position, and depicts a second embodiment of a securement netting delivery system.

FIG. 7 depicts the baler of FIGS. 1-6 just after the tailgate has opened to facilitate bale extraction or removal.

FIG. 8 is similar to FIG. 7, but depicts the baler of FIGS. 1-7 with the tailgate in a fully-open configuration and with the tilt roller pair rotated to permit transfer of the completed bale off of the tailgate and onto an adjacent transfer belt or wrapping table.

FIG. 9 is similar to FIG. 4, but is a schematic left side view of a baler according to a second embodiment of the present invention with the tailgate in its fully-closed or up position.

FIG. 10 is similar to FIG. 7, but depicts the baler of FIG. 9 with its tailgate in a fully-open configuration.

FIG. 11 is similar to FIG. 1, but is an isometric view of the front and left side of a baler according to a third embodiment of the present invention.

FIG. 12 is similar to FIG. 11, but depicts the baler according to the third embodiment with various side panels removed for clarity and with a second embodiment of a securement netting delivery system.

FIG. 13 is a schematic view in partial cross-section looking toward the left side of the baler depicted in FIGS. 11 and 12, with various components removed to clearly show the linkage for opening and closing the tailgate.

FIG. 14 depicts the baler of FIGS. 11-13 with the tailgate in its fully-open position, and the completed bale moving towards the distal edge of the tailgate.

FIG. 15 is an exploded isometric view of a mechanism for moving the bale chamber end plates away from the longitudinal ends of a precursor bale to allow easier extraction of the precursor bale from the baling chamber.

FIG. 16 is an isometric view of the mechanism of FIG. 15 when fully assembled.

FIG. 17 is an enlarged, fragmentary isometric view of the mechanisms of FIGS. 15 and 16.

FIG. 18 is a fragmentary, cross-sectional view of the mechanism depicted in FIGS. 15-17 taken along line 18-18 of FIG. 17 with the mechanism positioned to drive the bale chamber end plate against a longitudinal end of a bale during formation of that bale.

FIG. 19 is similar to FIG. 18, but is a fragmentary cross-sectional view of the mechanism of FIGS. 15-18, showing the mechanism when activated to move the bale chamber end plate away from a longitudinal end of the precursor bale after it has been formed in the baling chamber.

FIG. 20 is an isometric view depicting a bale chamber swing plate and a swing plate movement mechanism comprising a pair of hydraulic rams exploded away from the swing plate.

FIG. 21 is a fragmentary, cross-sectional view of the swing plate movement mechanism depicted in FIG. 20 with the swing plate positioned tightly against one longitudinal end of the precursor bale.

FIG. 22 is similar to FIG. 21, but depicts the swing plate configured or positioned to provide less clamping or holding force to the longitudinal end of the precursor bale, permitting delivery of the bale from the baling chamber.

FIG. 23 is a fragmentary, cross-sectional view of the second embodiment of the securement netting delivery system, taken along line 23-23 of FIG. 12.

FIG. 24 is a fragmentary view in partial cross-section of a first embodiment of the first and second net-spreading rollers, taken along line 24-24 of FIG. 23.

FIG. 25 is a fragmentary side view of one of the net-spreading rollers depicted in FIGS. 23 and 24.

FIG. 26 is an isometric view of an alternative net-spreading roller according to the present invention.

FIG. 27 is an enlarged view of the circled portion of FIG. 26.

FIG. 28 is an isometric view of a section of endless belt extending between a pair of lipped end plates.

FIG. 29 is similar to FIG. 28, but depicts a section of endless belt extending between a pair of lipless end plates.

FIG. 30 is a fragmentary, cross-sectional view taken along line 30-30 of FIG. 29, with the endless belt delivering a low to moderate compressing force to the material in the baling chamber.

FIG. 31 is similar to FIG. 30, but depicts the relationship between the endless belt and the end plate while the endless belt is delivering high pressure to the materials in the baling chamber.

FIG. 32 is a fragmentary isometric view of a portion of the baler depicted in FIGS. 11-14, with the sprayer assembly exploded away from the baler.

FIG. 33 is a cross-sectional view of the sprayer assembly, taken along line 33-33 of FIG. 32.

FIG. 34 is an exploded, isometric view of the sprayer assembly depicted in FIGS. 32 and 33.

FIG. 35 is similar to FIG. 13, but depicts the sprayer delivering an additive to the material being introduced into the baler.

FIGS. 36A, 36B, and 37C are schematic representations of a prior art tailgate having a relatively low deployment angle.

FIGS. 37A, 37B, and 37C are schematic views of the baler depicted in, for example, FIGS. 9 and 10, showing delivery of a bale off of a tailgate having enhanced bale-deployment characteristics.

FIGS. 38A and 38B are schematic depictions of the baler also shown, for example, in FIGS. 1-8, delivering a precursor bale off of the tailgate.

FIGS. 39-42 schematically depict the bulges that form at the throat of the compression chamber under different simulated conditions and baler configurations.

FIG. 43 depicts one possible embodiment for a super-charging hopper that may be used in conjunction with a baler, such as the balers of FIGS. 1-8, 9 and 10, and 11-14.

FIG. 44 is an isometric view of the baler of FIGS. 1-8 in one possible configuration for a baling system, with the alternative super-charging hopper shown in phantom.

FIG. 45 is similar to FIG. 44, but depicts one possible baling system that includes the baler also shown in FIGS. 11-14.

FIG. 46 depicts one possible overall system for processing and baling loose waste or other material, from initial collection through final disposition of a plurality of bales.

FIG. 47 is a side view in partial cross-section showing a forklift loading cylindrical bales into a shipping container.

FIG. 48 is an isometric view of the shipping container depicted in FIG. 47, full of cylindrical bales and with the container door still open.

FIG. 49 depicts a plurality of cylindrical bales being moved by truck.

FIG. 50 depicts a plurality of cylindrical bales being moved by railcar.

FIG. 51 depicts a bale handler on a dock loading cylindrical bales onto a floating barge.

FIG. 52 graphically depicts a sample of the volumetric efficiencies that may be obtained by using the balers according to the present invention to make better use of available landfill volume.

FIG. 53 depicts in phantom twenty rows of bales stacked on top of each other in, for example, a landfill, immediately after being placed in the landfill; and this figure also shows, on its right side, how the gaps between the cylindrical bales eventually close due to overburden and time.

FIGS. 54 and 55 are charts showing some of the volumetric efficiencies that are possible when using the balers according to the present invention rather than conventional means in a landfill.

FIG. 56 is an isometric view that schematically depicts a trash truck configured with a baler and used for curbside pickup of, for example, municipal solid waste.

FIG. 57 is a schematic side view of a baling system that could be used in lieu of a trash compactor behind a business that generates a fairly high volume of waste.

FIG. 58 is a side view of a baling system mounted on a barge, with or without spuds.

### DETAILED DESCRIPTION OF THE INVENTION

The balers of the present invention are configured to provide high-density bales of a variety of different possible materials including, for example, municipal solid waste, construction and demolition waste, medical and other hazardous waste, mine trailings, dirt, agricultural products, and anything else that needs to be efficiently contained, moved, stored, or disposed of. As explained further below, the balers according to the present invention are highly configurable and are thus capable of producing bales of a wide variety of bale densities, lengths, and diameters. These balers include special hardware and process control features that allow a user to select or “dial in” desired bale parameters and then produce the desired bales at high speeds with minimal interruptions. If desired, these balers can produce a hermetically sealed, essentially self-contained bale that facilitates easy movement of a high volume of material to, for example, a landfill, if the baled material is to be disposed of, or to a power plant, if the baled material will be used in the production of energy for delivery to consumers and businesses. These balers are particularly beneficial when a large volume of any type of material needs to be packaged in a secure and portable configuration. For situations where the materials to be baled may be moist and would thus produce undesirable leachate if the materials were compressed using various conventional balers, the production of undesirable leachate may be controlled via the process and the film wrapping that are both used by the balers according to the present invention. In particular, the tumbling and pressing actions tend to disperse any moisture contained within the materials being baled throughout the bale.

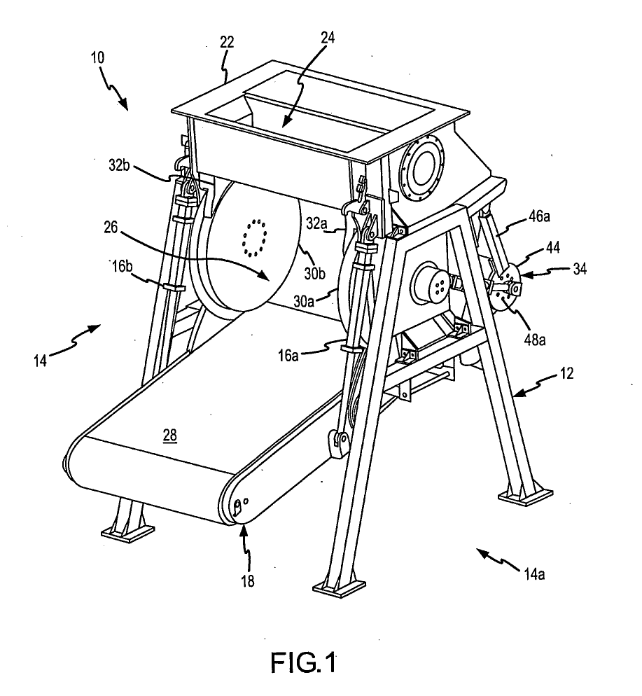

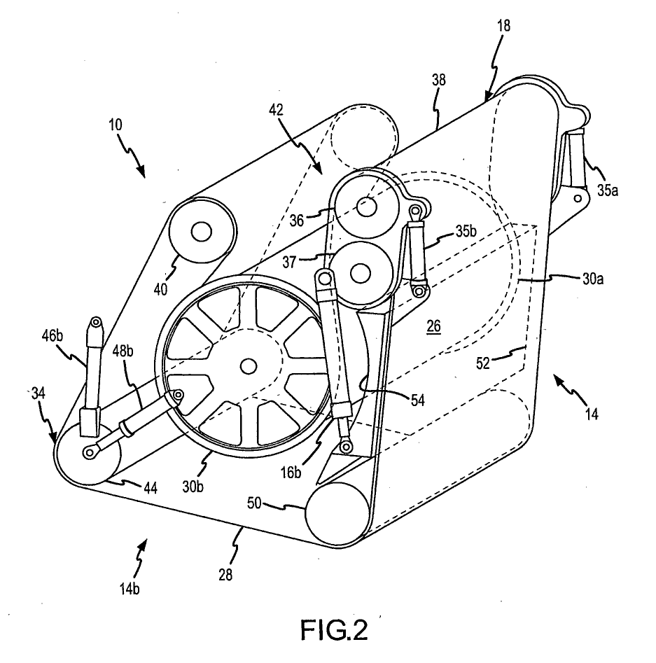

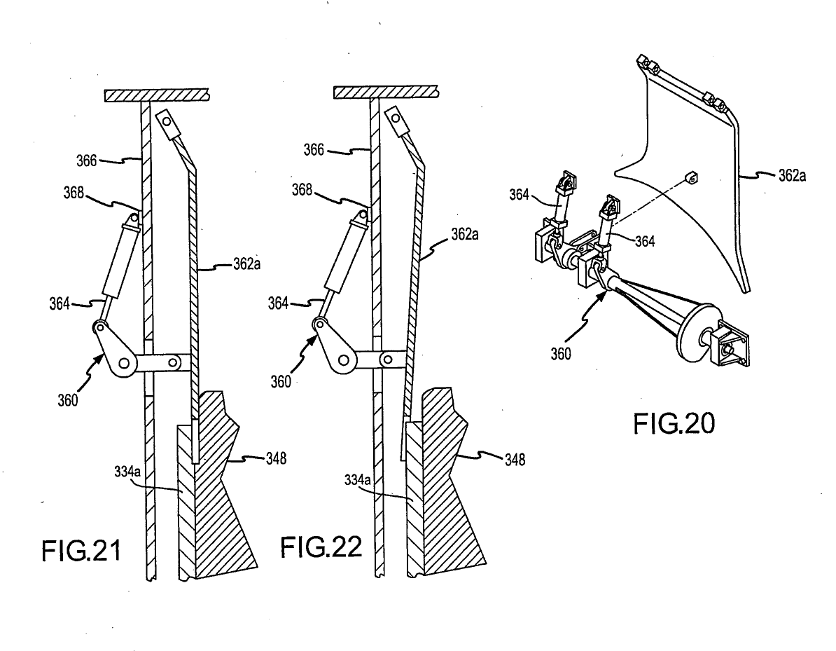

FIGS. 1-8 depict a baler according to a first embodiment of the present invention in various operating configurations. In FIG. 1, the baler according to the first embodiment is shown in an isometric view of the front and right side of the baler. In this particular embodiment, a pair of hydraulic rams are used to open a tailgate that permits a formed bale to be dispatched from the baler. In FIG. 1, this tailgate is shown in its fully-open configuration. During the creation of a bale, the tailgate would be moved to its fully-closed configuration (see, e.g., FIGS. 2-6). The material to be baled is introduced into the baler at a feed opening or throat defining an entry path into the baler. The baling chamber is formed when the tailgate is fully-closed by the endless compression belt and the two end plates. Also visible in FIG. 1 and, for example, FIGS. 20-22, are a pair of swing plates or panels that help guide the material to be baled into the space between the end plates of the baling chamber. As explained further below, these swing plates or panels may also be used to keep the bale from immediately rolling out of the baling chamber as the tailgate is moved from its fully-closed position to its fully-open position. Along the right-hand edge of FIG. 1, it is also possible to see the tensioner assembly, which is used to control the amount of tension in the endless compression belt and thus the density of the bale that is ultimately formed in the baling chamber.

FIG. 2 is a schematic, isometric view of the left side and front of the baler depicted in FIG. 1. In FIG. 2, however, the support frame and several other features and components of the baler have been removed to more clearly show the rollers or cylinders and the path of the endless compression belt used to form the bales. In the upper right-hand portion of FIG. 2, a pair of tilt rollers (idler rollers) are visible. In particular, a distal tilt roller is present adjacent to the distal edge of the tailgate and a proximal tilt roller is immediately adjacent to the distal tilt roller. As explained further below in connection with some of the other figures, the tilt roller pair may be tilted toward and away from the baling chamber by a pair of tilt rams that are shown in FIG. 2. To left of the tilt roller pair in FIG. 2, is a driven roller or cylinder. After the endless compression belt travels over the tilt roller pair, it extends around the outer circumference of the end plates and then around the driven roller. The gap between the tilt roller pair and the driven roller defines the material entry path or throat through which materials to be baled are introduced into the baling chamber. The endless belt then travels around a tensioner assembly that includes another roller or cylinder. This tensioner roller is pivotably mounted by a pair of arms that are bolted to the support frame. A pair of tensioner rams may be activated to move the tensioner roller leftward or rightward in FIG. 2. This motion of the tensioner roller changes the length of the path that the endless compression belt must follow, thereby increasing or decreasing the amount of pressure being applied to the material in the baling chamber. In the embodiment depicted in FIG. 2, an idler roller is also present. This latter idler roller, which is shown in FIG. 2 as the lower right-hand roller, may be a driven roller that could be used in conjunction with the driven roller shown in the upper left-hand portion of FIG. 2, or it could be used as a backup driven roller. Also shown substantially in phantom in FIG. 2 is a shaping plate that extends between the tilt roller pair and the idler roller. This shaping plate includes a contoured surface that helps form the curved side wall of the cylindrical bale formed in the baler.

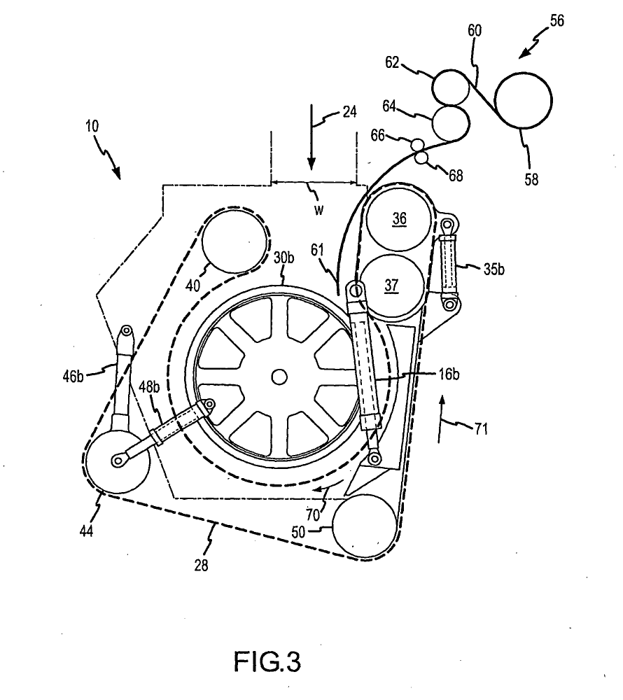

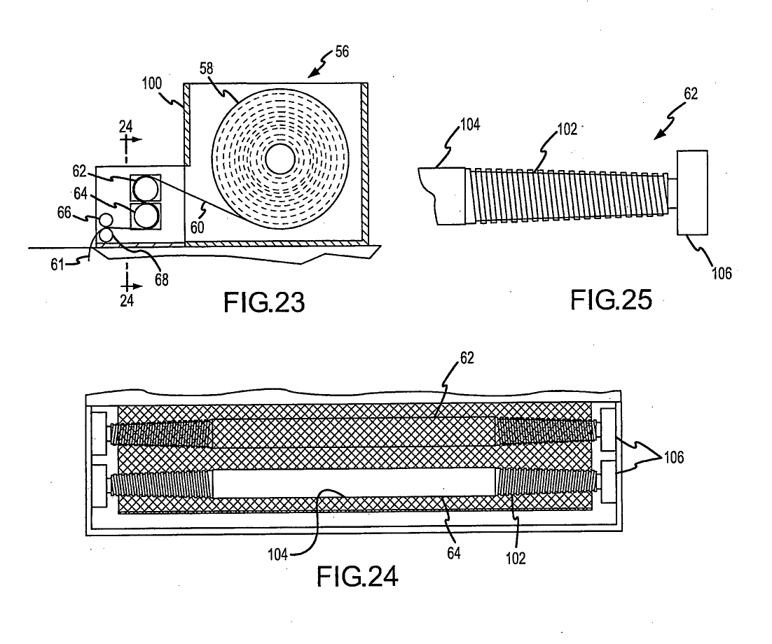

FIG. 3 is a schematic cross-sectional view of the baler of FIGS. 1 and 2 during the initial phase of a bale formation cycle. The arrow shown at the top of the drawing shows the entry path for the material to be baled. In this initial configuration, the entry path or throat of the baler is in its least constricted configuration. This entry path width may be, for example, approximately thirty-one inches. FIG. 3 also shows in cross-section a first possible embodiment of a securement netting delivery system. In this particular embodiment, the delivery system comprises a netting supply roller, which dispenses yarn or netting for initial securement of the baled materials to form a “precursor bale” (i.e., a bale that is not completely enveloped in film or foil since its longitudinal ends remain uncovered. In particular, the netting travels over a first netting roller, which may be smooth, then a second netting roller, which may include grooves or helical channels to help spread the securement netting toward the longitudinal ends of the roller, as explained further below. In the embodiment depicted in FIG. 3, the smooth netting roller and the grooved netting roller are directly adjacent to each other, but need not be (see, e.g., the alternative embodiment shown in FIG. 23 where there is a gap between these two rollers). The securement netting next travels between a pinch roller and a driven roller, which pull the netting off of the netting supply roller and around both the smooth netting roller and the grooved netting roller. The driven roller may include, for example, a neoprene surface to help this roller trap the securement netting against the pinch roller making it possible for the driven roller to thereby pull the netting off of the supply roller. The free end of the securement netting is thereby fed into the baling chamber as shown in FIG. 3. In particular, during the formation of a bale, the belt moves in the direction of the arrows shown in FIG. 3. Thus, as the baling chamber begins to fill with material, the free end of the securement netting eventually gets trapped and pulled into and around the formed bale. As explained further below, this securement netting thus makes it possible to keep the baled materials together until the precursor bale (i.e., the bale that has been formed and then wrapped with one or more layers of securement netting) is delivered to a wrapping station or transport.

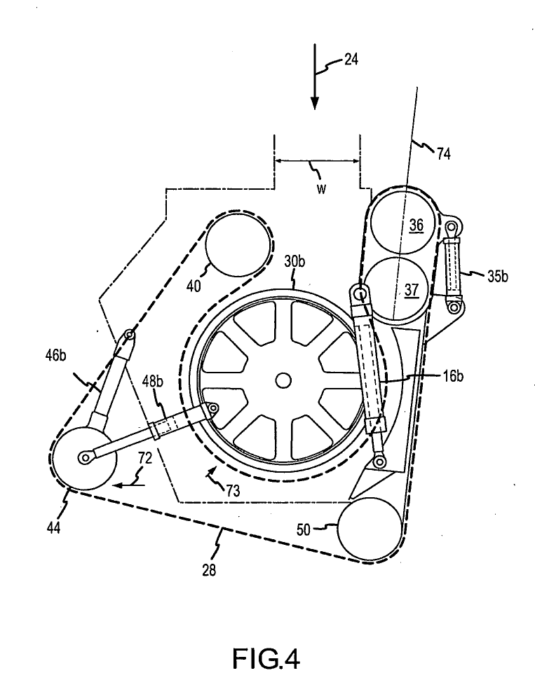

FIG. 4 is similar to FIG. 3. However, in FIG. 4, the tensioner ram has been extended slightly, thereby driving the tensioner roller in the direction of the arrow shown in the lower left-hand portion of FIG. 4. This movement of the tensioner roller increases the length of the circuitous pathway followed by the endless compression belt. This, in turn, moves the endless compression belt in the direction of the small arrow adjacent to the baling chamber end plate shown in FIG. 4. When the belt moves in this direction, it compresses the material in the baling chamber. In particular, the material in the baling chamber is moved upward and rightward in FIG. 4 towards the proximal tilt roller (an idler roller), which acts as a compression roller when the baler is in this configuration. Thus, the material being fed into the throat of the baler is being pressed by the upward and rightward motion of the belt against the proximal tilt roller and the outer surface of the bale that is being formed. In a typical operation, the belt speed is set such that the material forming the bale passes by the proximal tilt roller, in this configuration, between ten and forty times per minute. In other words, the proximal tilt roller potentially acts on or presses against each point on the outer surface of the cylindrical bale ten to forty times per minute, which evenly distributes the material in the bale, including any potential moisture in the materials that are being baled.

In FIG. 5, the tensioner ram has been extended even further, thereby driving the tensioner roller in the direction of the arrow shown in the lower left-hand portion of FIG. 5. This, in turn, further lengthens the path that the endless compression belt must follow, which causes the belt to further compress the material in the baling chamber. At this point in the process, the pressures inside of the baling chamber have increased substantially. Material being fed into the throat of the baler along the entry path represented by the entry path arrow at the top center of FIG. 5, may experience difficulty being incorporated into the bale. In other words, the newly introduced materials may tend to sit in the gap between the tilt roller pair and the driven roller and “boil” or churn without being drawn into the bale itself.

In order to deliver more frictional force to these materials, thereby making it possible to pull them into the bale, the tilt roller pair may be angled or tilted toward the baling chamber as shown in FIG. 5. In particular, the nearly vertical line in the upper right-hand portion of FIG. 5 represents the edge of a plane extending through the longitudinal centroid of the tilt rollers or cylinders when in their initial configuration shown in FIGS. 3 and 4. In the configuration depicted in FIG. 5, with the tilt roller pair leaning or tilting toward the baling chamber, more useful friction from the endless compression belt may be delivered to the material to be ingested into the bale. Thus, as the bale density increases, thereby making it more difficult to pull additional material into the bale, the deflection or tilting of tilt rollers makes it possible to deliver additional frictional force to the material so that that material may be actually pulled into or ingested into the bale. The rate at which this deflection is accomplished and the ultimate deflection angle achieved, is fully controllable by the operator of the baler.

As may be clearly seen by comparing the throat size in FIGS. 3 and 4 to the throat size in FIG. 5, when the tilt roller pair is leaned toward the compression chamber, the entry path or throat available for introducing additional material to the bale is reduced. For example, the throat size may be on the order of thirty-one inches in FIGS. 3 and 4, whereas in the configuration of FIG. 5, the throat may be reduced down to twenty-four inches. At this point in the process, the reduction in the size of the entry path is less critical than the need to increase the force delivered to the material to be ingested. Since the bale is substantially formed, the amount of material being delivered has decreased. Thus, the reduction in the size of the entry path is tolerable.

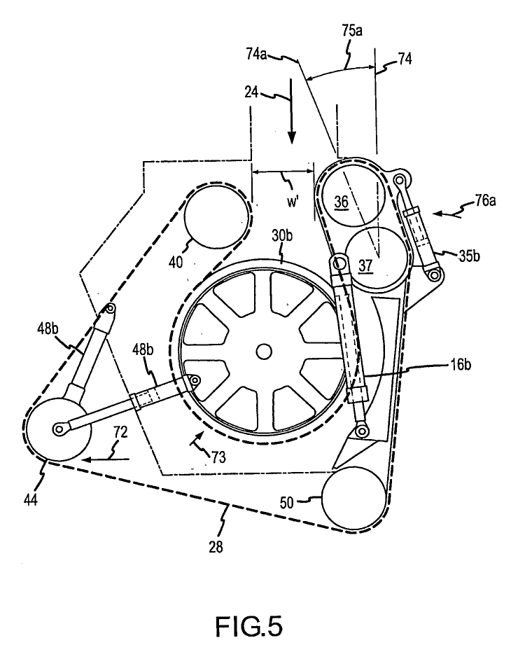

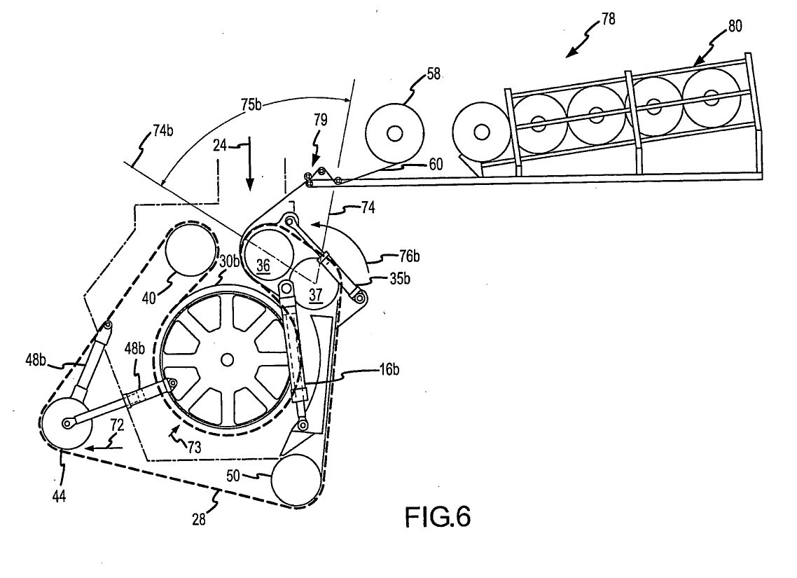

As shown in FIG. 6 which is similar to FIGS. 3 and 4, as the process progresses further, the tensioner ram reaches its maximum extension (i.e., the maximum extension capable or the maximum extension requested by the controller). At this point, the bale density is reaching the maximum possible density or the maximum target density. As discussed above in connection with FIG. 5, as the bale density increases, it also becomes increasingly difficult to ingest additional material into the bale. Thus, in response, the tilt roller pair may be further leaned or rotated toward the compression chamber. In FIG. 6, for example, the lean angle or tilt angle of the tilt roller pair may be on the order of 60°. At this point, very little additional material is being introduced into the bale. Thus, the fact that this further restricts the throat or entry path available for material to be introduced into the bale does not create a problem. With the tilt rollers in this configuration, however, the maximum amount of frictional force may be delivered to any material in the gap between the tilt roller pair and the driven roller, thereby making it possible to pull this last material into the bale.

FIG. 6 also shows a second embodiment of a securement netting delivery system. This securement netting delivery system is similar to the system depicted in, for example, FIG. 3. However, the netting rollers are further offset from the configuration of the netting rollers depicted in FIG. 3, and the netting coming off of the netting supply roller is threaded through the netting rollers differently. The securement netting delivery system depicted in FIG. 6 also include a securement netting supply rack to keep a supply of securement netting conveniently available. Although not shown in FIGS. 3 and 6, a cutter is also provided to cut the securement netting after the precursor bale has been formed. The securement netting may, for example, be cut prior to the tailgate being opened as the tailgate is being opened, or after the tailgate has been opened but before the precursor bale has been removed from the baler.

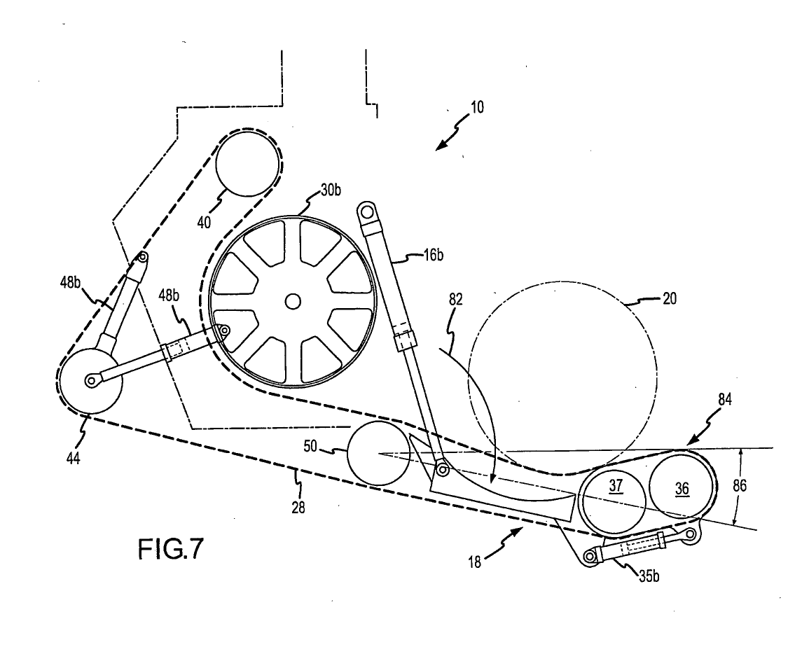

FIG. 7 depicts the baler of FIGS. 1-6 with the tailgate rotated in the direction of the curved arrow in FIG. 7 to its fully-open configuration. In particular, when the tailgate ram is activated and extends, the tailgate is pivoted from the fully-closed configuration depicted in FIGS. 3-6 to the fully-open configuration depicted in FIG. 7. A formed and “secured” bale is shown in FIG. 7 in phantom. This bale comprises a highly compressed mass of material that is being held in a “precursor” bale configuration by the securement netting. The amount of securement netting delivered to the outer surface of the bale depends upon the material from which the netting is formed, the density of the bale, the type of material that has been baled, and potentially a number of other factors.

As shown in FIG. 7, when the tailgate initially opens, the formed precursor bale is supported on the endless compression belt and is prevented from rolling off of the baler by the rotated tilt roller pair. In particular, the tilt roller pair may remain in the configuration depicted in FIG. 6 as the tailgate is opened, or the tilt roller pair may be rotated back to an intermediate angle like that shown in FIG. 5 before or as the tailgate is opened. Either way, the tilt roller pair prevents the precursor bale from rolling off of the distal edge of the tailgate until an appropriate time. In the embodiment depicted in FIG. 7, the tailgate slope angle may be greater than what has been possible with prior art configurations. For example, the tailgate slope angle may be on the order of 12°, which, as described below in connection with FIG. 8, facilitates easy movement of the precursor bale off of the tailgate.

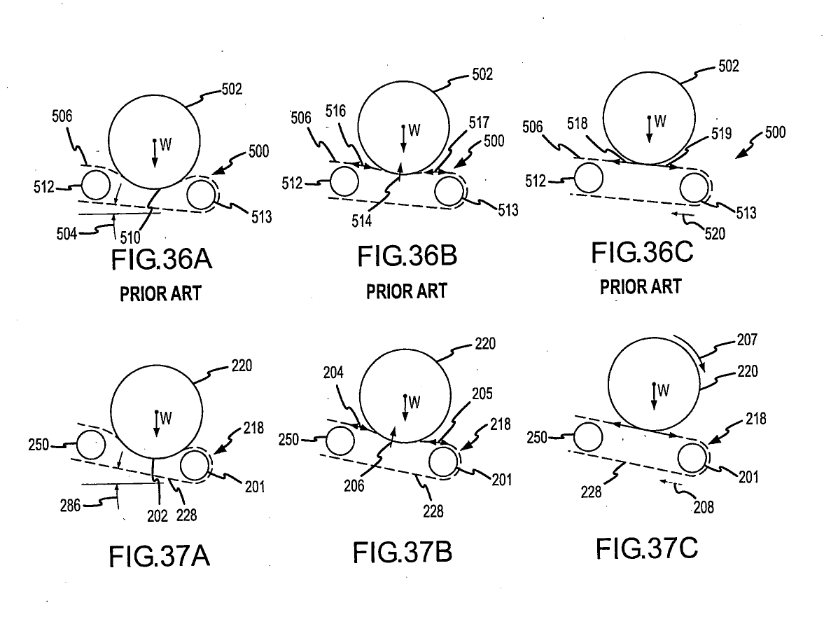

In FIG. 8, the precursor bale is being delivered to an adjacent transfer belt or wrapping table. In particular, by comparing FIGS. 7 and 8, it is possible to see that the tilt ram has been activated to rotate the distal tilt roller clockwise relative to the proximal tilt roller, which in turn lets the precursor bale roll off of the tailgate to a waiting transfer belt or wrapping table. Since the tilt roller pair makes it possible to control the movement of the precursor bale (e.g., it makes it possible to keep the precursor bale from inadvertently rolling off of the tailgate), it is possible with this configuration to unload the precursor bale off of the tailgate without movement of the endless compression belt. Without the tilt roller pair, it can be problematic to achieve the tailgate slope angle depicted in FIGS. 7 and 8. If, in turn, it is not possible to lower the tailgate as far as what is shown in FIGS. 7 and 8, the trough or depression in which the bale is shown in phantom in FIG. 7, may become much deeper. As explained further below in connection with, for example, FIGS. 36A-38B, the deeper this trough is and the shallower the tailgate slope angle, the more difficult it may be to remove the bale from the tailgate and the more damaging the process can be on the equipment, particularly the endless compression belt.

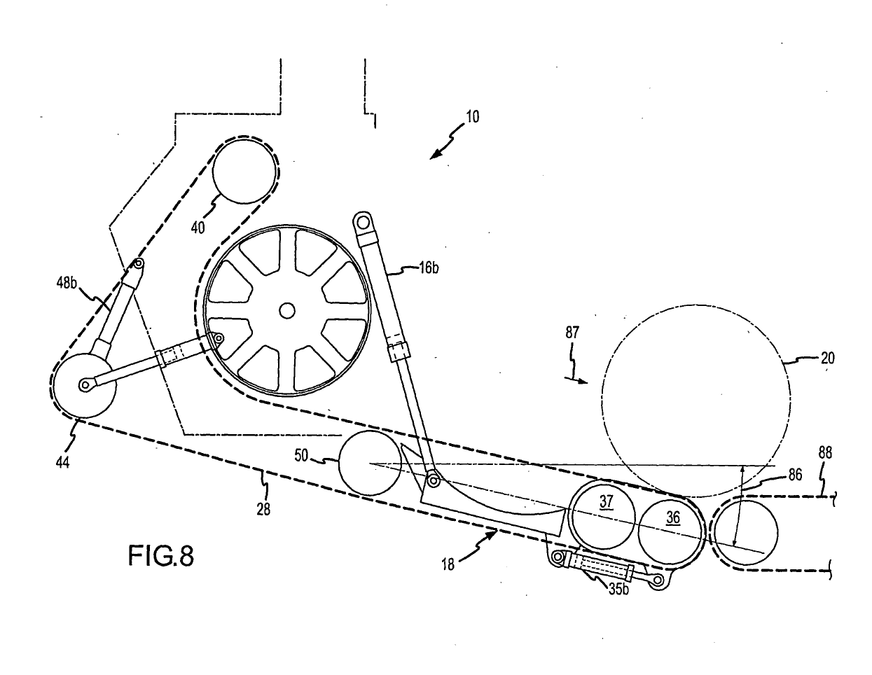

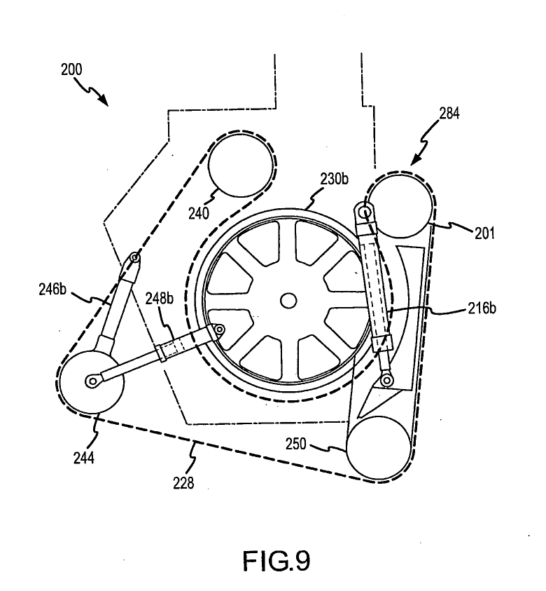

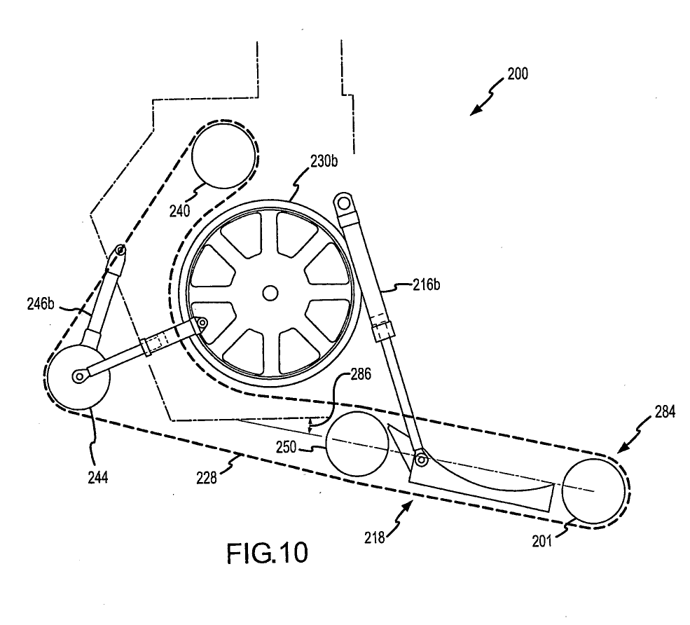

FIG. 9 shows a baler according to a second embodiment of the present invention. The primary difference between the first embodiment, shown in FIGS. 1-8, and the second embodiment, shown in FIGS. 9 and 10, is the fact that the second embodiment does not include the tilt roller pair at the distal edge of the tailgate. In particular, in FIGS. 9 and 10, a single compression roller is shown. In this alternative configuration, as with the first embodiment depicted in FIGS. 1-8, the diameter of the end plates has been adjusted to permit higher compression of the materials that are being baled.

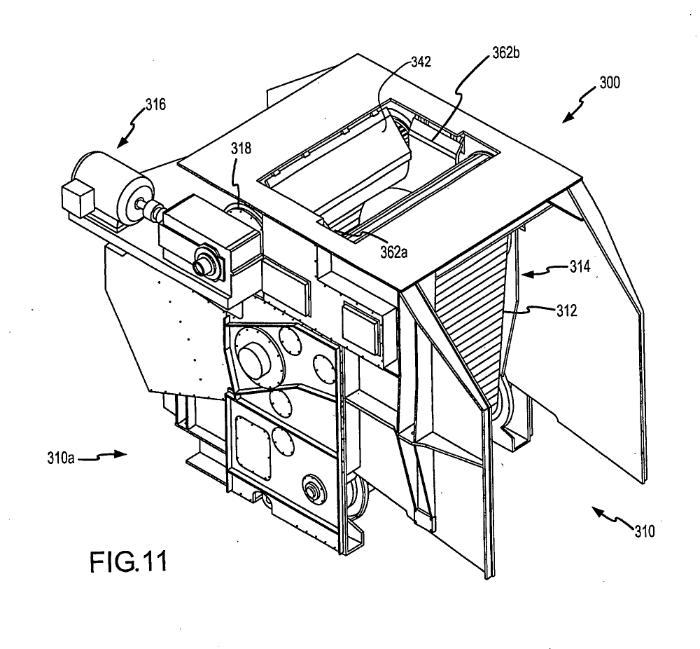

FIGS. 11-14 depict a baler according to a third embodiment of the present invention. In particular, FIG. 11 is an isometric view showing the front and left side of the baler according to the third embodiment. As in the prior embodiments, an endless compression belt is used to create the baling chamber. A portion of this endless compression belt may be clearly seen in FIG. 11. This third embodiment of the baler according to the present invention includes a different mechanism, explained further below for raising and lowering the tailgate. The alternative mechanism for raising and lowering the tailgate may be used in conjunction with the roller configurations depicted in FIGS. 2-10, particularly the tilt roller pair shown to good advantage in FIGS. 2-8.

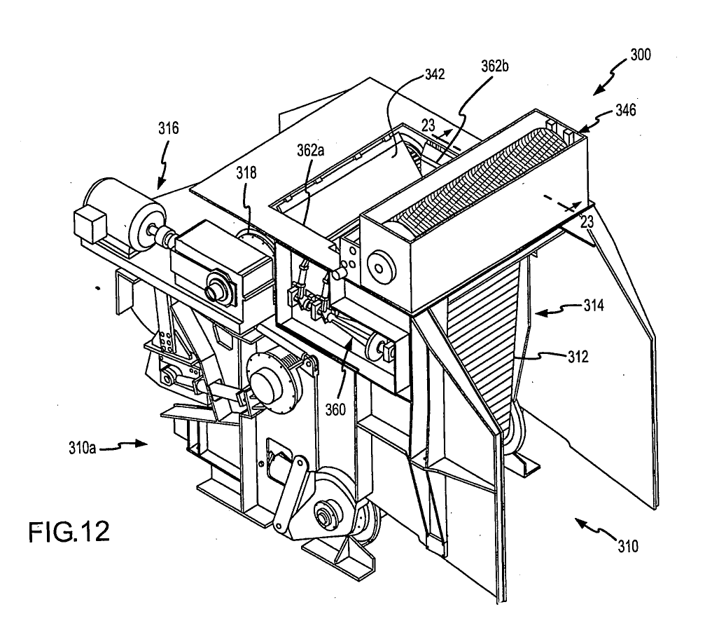

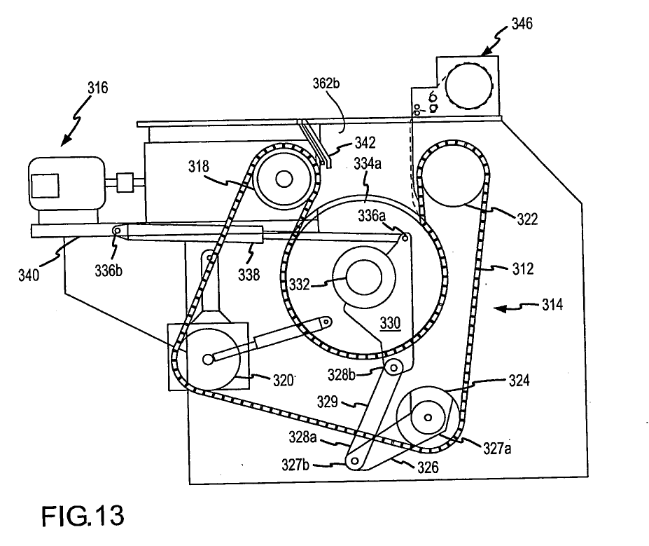

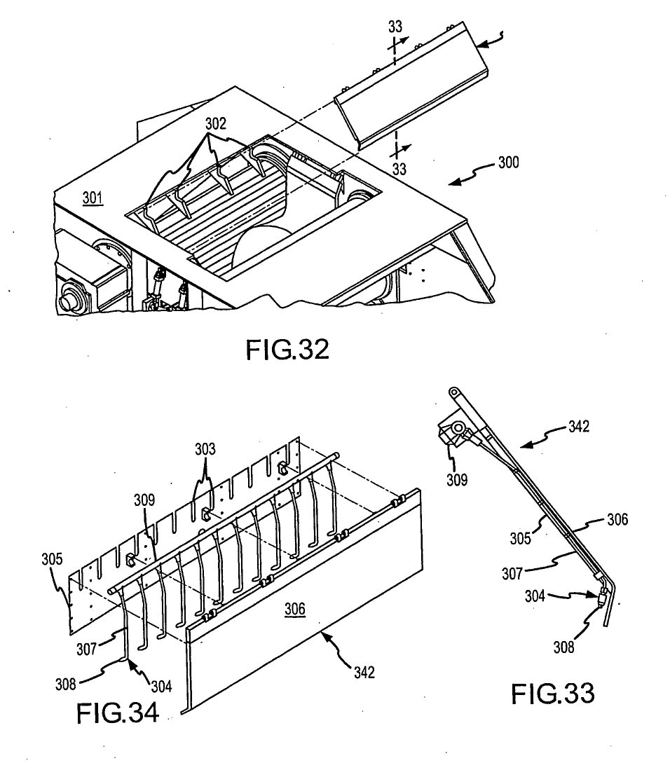

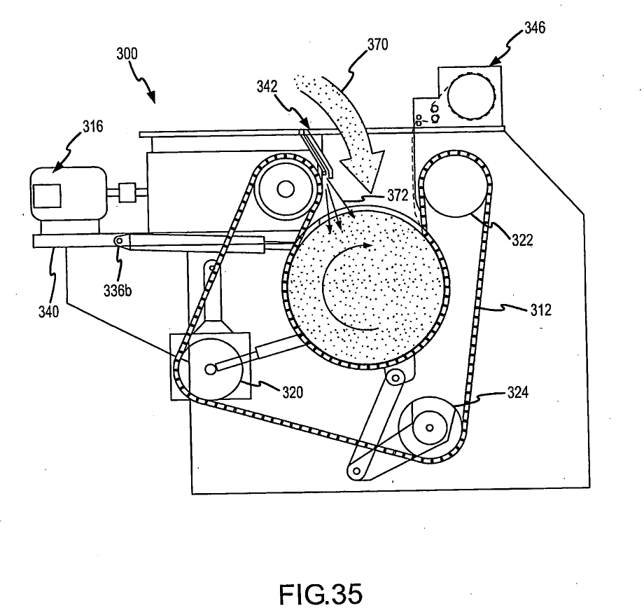

FIG. 12 is similar to FIG. 11, but various access panels and shielding panels have been removed to reveal the mechanical linkage used to move the tailgate in this third embodiment of the present invention. Also visible in FIG. 12 is the motor and transmission that drive the driven roller to move the endless compression belt. FIG. 13 is a schematic side view of the baler depicted in FIGS. 11 and 12. As shown in FIG. 13, the endless compression belt follows a serpentine or circuitous path around a plurality of rollers including a tensioning roller shown in the lower left-hand corner of FIG. 13, a driven roller shown in the upper left-hand portion of FIG. 13, a compression roller shown in the upper right-hand portion of FIG. 13, and an idler roller shown in the lower right-hand portion of FIG. 13. Again, the idler roller may be an additional driven roller or an alternative driven roller in any of the baler embodiments depicted and described herein. Again, even though the third embodiment is depicted in FIGS. 11-14, with the single compression roller in the upper right-hand portion of, for example, FIG. 13, the tilt roller pair depicted in FIGS. 2-6 may also be used with the mechanism depicted in FIGS. 11-13 for raising and lowering the tailgate. Referring most specifically to FIG. 13, the mechanical linkage for raising and lowering the tailgate will be described next. Starting at the lower right-hand corner of FIG. 13 with the idler roller, an idler roller link arm is present with one of its ends attached to the axis of rotation of the idler roller, and its opposite end attached to one end of a pivot arm or link. The opposite end of this pivot arm or link is connected to a pivot arm clamp assembly aligned with the center axis of the baling chamber and the baling chamber end plates. The pivot arm clamp assembly includes a hydraulic cylinder attachment point to which the tailgate activation hydraulic cylinder is attached. The opposite end of the tailgate activation cylinder is attached to the support frame for the baler. Also visible in FIG. 13 is the optional sprayer assembly that will be described further below in connection with FIGS. 32-34.

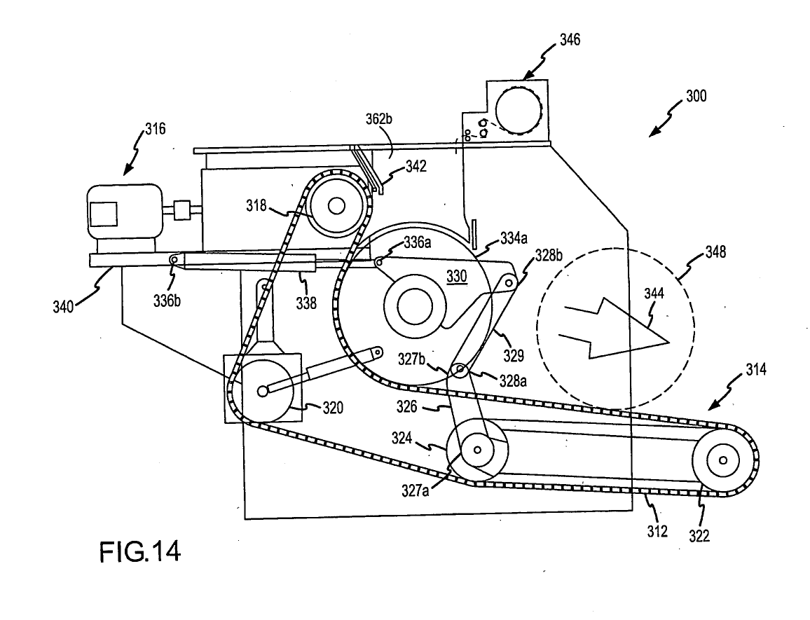

By comparing FIGS. 13 and 14, it is possible to see how the mechanism for raising and lowering the tailgate functions. In particular, the tailgate activation cylinder is shown in FIG. 13 with its ram extended. To open the tailgate, the ram of the tailgate activation cylinder is retracted, which rotates the pivot arm clamp assembly counterclockwise in FIGS. 13 and 14 to the position shown in FIG. 14. This pivoting motion of the pivot arm clamp assembly thereby pulls on the pivot arm, raising it from the position shown in FIG. 13 to the position shown in FIG. 14. As this pivot arm is raised by the pivot arm clamp assembly, the pivot arm itself pulls on one end of the idler roller link arm. As this end of the idler roller link arm is raised, that rotates the tailgate to the fully-open position depicted in FIG. 14. The precursor bale, which is shown in phantom in FIG. 14, can then be moved off of the tailgate. As previously discussed, a securement netting delivery system may be present on the baler. In particular, in FIGS. 12-14 such a securement netting delivery system similar to the one depicted in FIG. 3 is present.

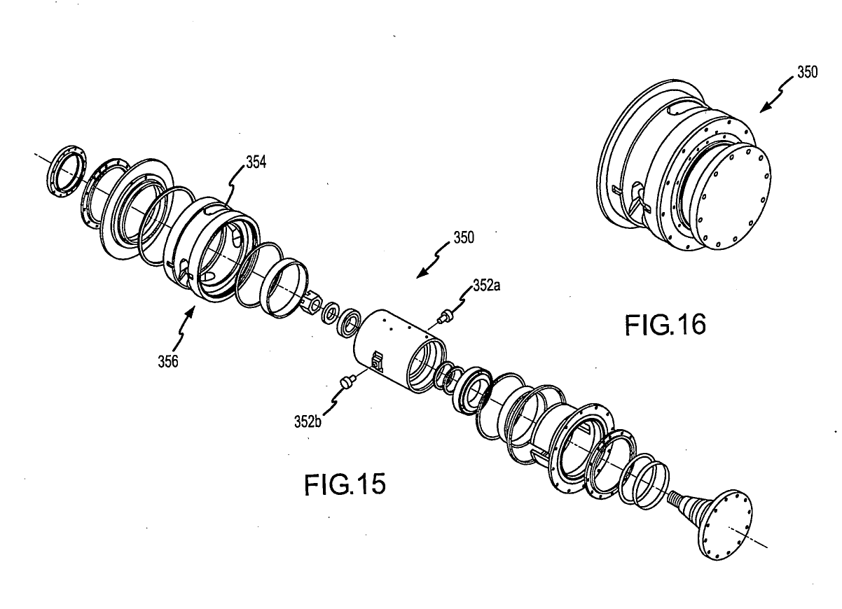

As the linkage just described opens the tailgate, the bale chamber end plates are simultaneously displaced away from the longitudinal ends of the precursor bale, thereby readying the bale for removal from the baling chamber. The movement of the bale end plates away from the longitudinal ends of the bale is accomplished in this embodiment by a baler hub assembly depicted in FIGS. 15-19.

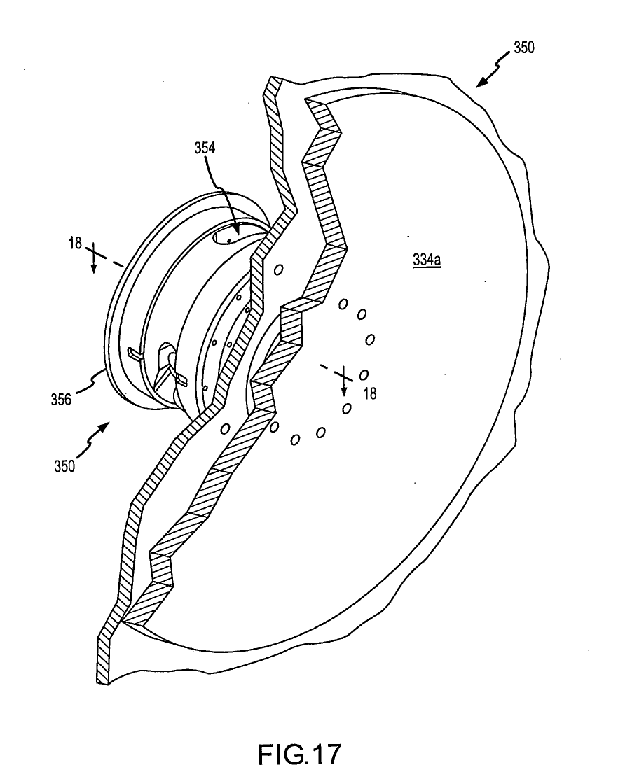

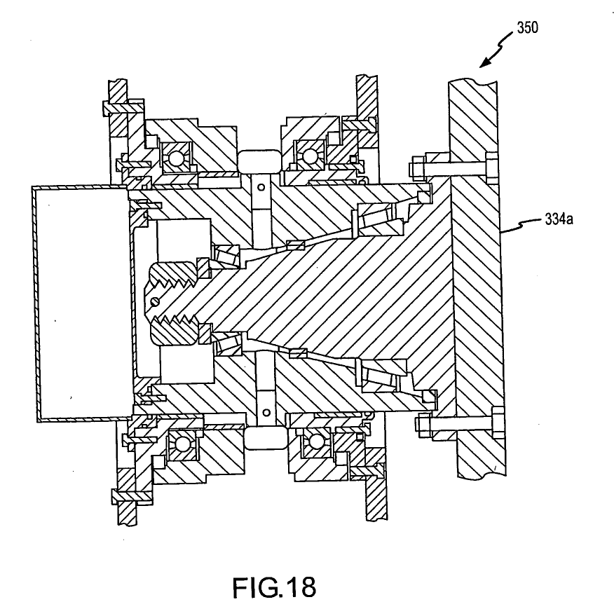

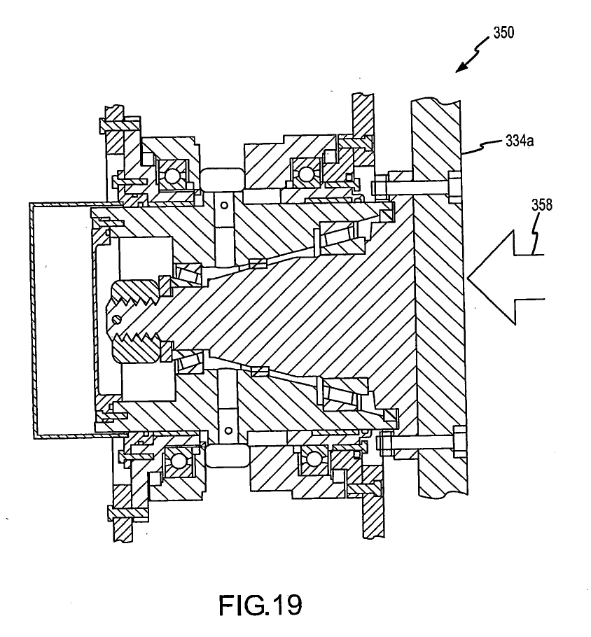

FIG. 15 is an exploded isometric view of the baler hub assembly. FIG. 16 is an isometric view of the baler assembly in its fully assembled configuration. The baler hub assembly is the mechanism that coordinates end plate movement with the opening and closing of the tailgate. As may be clearly seen in FIGS. 15-17, the cam follower or pin rides in a slot (see, e.g., FIG. 17). This slot follows an angled path around the outer circumference of the cam follower housing. Thus, as the tailgate is opened and closed, the cam follower, riding in the cam follower housing, creates the longitudinal motion of the end plates toward or away from the longitudinal ends of the precursor bale. This longitudinal movement of the bale end plate is represented by the large arrow on the right-hand side of FIG. 19. Review of FIGS. 15-19, including a comparison of FIGS. 18 and 19, clearly shows how the angular motion of the pivot arm clamp assembly results in longitudinal movement of the end plates relative to the longitudinal ends of the precursor bale. The distance that the end plates move longitudinally as the tailgate opens and closes is controllable by the configuration of the cam follower slot and may be, for example, on the order of a couple of inches.

FIGS. 20-22 show further details concerning the hydraulic and mechanical linkage that moves or swings the swing plates into and out of position. This mechanism is also shown in, for example, FIG. 12, and these swing plates are visible in, for example, FIGS. 13 and 14. When the hydraulic rams visible in FIGS. 12 and 20 are activated, the swing plates may be moved into and out of contact with the longitudinal ends of the precursor bale. In particular, each swing plate is mounted to the support frame for the baler by a mounting bracket. The mounting bracket or brackets permit the swing plate to move toward and away from the longitudinal end of the bale under the influence of the hydraulic rams and their associated cams and linkages.

If, for example, the end plate moving mechanism described above in connection with, for example, FIGS. 15-19, moves the bale chamber end plates away from the longitudinal ends of the bale as the tailgate is opened, the bale may start to roll out of the bale chamber and off the tailgate earlier than desired. In order to control this exit or departure of the bale from the bale chamber, the swing plates may be used. In FIG. 21, one of the swing plates is shown being pressed into a longitudinal end of a precursor bale. In several embodiments of the present invention, a similar swing plate would be present at the opposite end of the precursor bale. In this configuration, when the tailgate is opened, the bale chamber end plates would move away from the longitudinal end of the precursor bale. As shown in FIGS. 21 and 22, the bale chamber end plate need not come completely out of contact with the longitudinal ends of the precursor bale. Rather, the mechanism depicted most specifically in FIGS. 15-19 may merely move the bale chamber end plates enough to prevent them from longitudinal squeezing the bale, which would prevent or inhibit removal of the bale from the baling chamber. Thus, for purposes of this discussion, it is assumed that, in FIGS. 21 and 22, a mechanism like the one shown most specifically in FIGS. 15-19 has caused the bale chamber end plates to relieve the pressure they may have been putting on the longitudinal ends of the bale. At this point, in the configuration depicted in FIG. 21, the swing plate at each end of the bale continues to be pressed toward the longitudinal end of the bale by the swing plate hydraulic ram until it is time to release the bale from the bale chamber. In FIG. 22, these swing plate hydraulic rams have been activated to pull the swing plates away from the longitudinal ends of the precursor bale, thereby releasing the bale to roll out of the compression chamber and off of the tailgate.

As shown to good advantage in FIGS. 21 and 22, the bale chamber end plates may not extend to or be terminus with the outer circumference of the precursor bale. When the end plates are smaller than the circular cross-section of the bale, it is possible to more firmly squeeze or compress the material to reach the high compressions or bale densities that may be required for particular applications.

FIGS. 3, 6, and 12-14, among others, depict securement netting delivery systems means. In order to operate the balers according to the present invention as efficiently as possible, it is important that the securement netting delivery means is able to reliably deliver securement netting around the outer circumference of the compressed materials comprising the bale. If, for example, the securement netting does not extend substantially from one longitudinal end of the bale to the other longitudinal end of the bale, when the tailgate is lowered or opened, the precursor bale may rupture or burst. If this were to occur, it would be necessary to shut down the baler until the scattered debris and busted bale could be removed from the apparatus in order to commence full operation of the baler again.

In order to help ensure that the securement netting is spread to the longitudinal ends of the baled material and does not get bunched up, one or more of the netting rollers may include helical grooves. Additional, or alternatively, one or more of the netting rollers may be tapered.

FIGS. 23-25 depict, for example, a securement netting delivery system that includes two grooved and tapered netting rollers. FIG. 23 is a fragmentary cross-section view of the securement netting delivery system. A supply roll of securement netting is mounted within a housing (the housing may or may not be present) and delivers, on demand, securement netting. In this particular embodiment, the securement netting follows a serpentine path around a first spreading roller and then a second spreading roller. After leaving the second spreading roller, the securement netting is passed between a driven roller and a pinch roller. The free end of the securement netting, is then fed into the baling chamber at the appropriate time to deliver a layer of netting around the exterior of the bale. Although this securement netting is typically delivered to the outside of the bale as a final step prior to removing the bale from the baling chamber, in some applications, it could be possible to embed netting in the bale at various stages during the formation of the bale to stabilize the materials being baled.

As may be clearly seen in FIG. 23, with the serpentine path that the netting follows around the first and second spreading rollers, the securement netting is in contact with one or both of these rollers along a substantial portion of the outer surface of the roller. This extensive contact with the outer surface of the spreading rollers provides an opportunity for the spreading rollers to influence the feeding of the securement netting. For example, as shown in FIG. 24, which is a view looking in the direct of line 24-24 in FIG. 23, the spreading rollers each include a plurality of helical grooves at each longitudinal end. Once the netting is properly threaded around these first and second spreading rollers, the helical grooves at each longitudinal end of each spreading roller tends to drive the longitudinal edges of the netting toward the longitudinal ends of the rollers, thereby keeping the securement netting spread over substantially the entire length of the bale being created in the baling chamber. Each section of grooves may be, for example, four to eighteen inches long to ensure that there are sufficient grooves present to have the desired influence on the securement netting.

Although both intermediate rollers are shown in this embodiment (FIGS. 23-25) as including net-spreading grooves on each end, it may only be necessary to have these net-spreading grooves on one of the two rollers. In a variant of the depicted embodiment, an additional, compression roller may be present to press the securement netting firmly against one of the spreading rollers to further enhance, for specific situations, the effect of the spreading roller or rollers on the securement netting. As clearly shown in FIGS. 24 and 25, the spreading rollers may also taper toward one or both of their longitudinal ends. The tapering is some what exaggerated in FIGS. 24 and 25. In reality, the taper may be on the order of a 2.5 mm change in diameter for the spreading roller from the center of the spreading roller to each of the longitudinal ends of the spreading roller. Further, one or both of the spreading rollers may include a flat section near its longitudinal center, possibly to support the center of the roller as a location where a bearing could be placed. In FIGS. 24 and 25, each longitudinal end of each spreading roller is supported by a bearing block that allows the spreading rollers to spin under the influence of the driven roller.

FIGS. 26 and 27 depict an alternative net-spreading roller. In this alternative embodiment of the net-spreading roller, the grooves extend from the center of the roller outwardly toward each end of the roller. FIG. 27 shows an enlarged view of the circled portion of FIG. 26, where the two groove patterns meet at the center of the net-spreading roller. Although the alternative net-spreading roller depicted in FIGS. 26 and 27 can influence the netting more than the rollers depicted in, for example, FIG. 24, because of the presence of more grooves, the ultimate effectiveness of the roller depicted in FIGS. 26 and 27 may depend to a large extent on how carefully the netting is originally aligned.

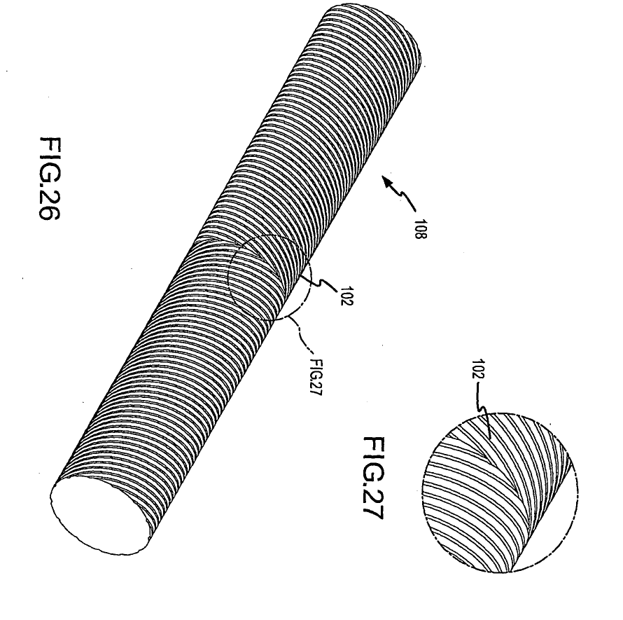

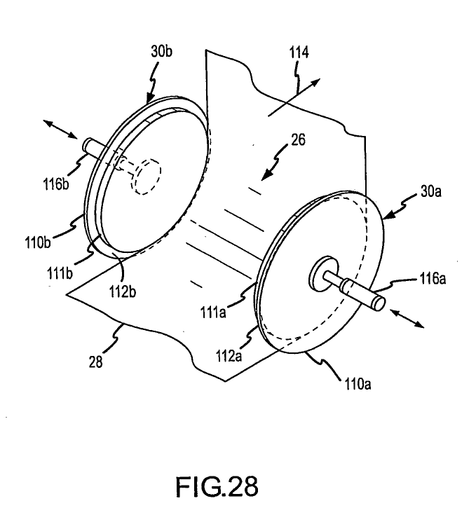

FIG. 28 shows a section of endless belt and two bale chamber end plates. The bale chamber end plates depicted in FIG. 28 are “lipped” end plates. In other words, the end plates include both an outer circumferential surface and a smaller, belt-support lip or edge. As shown in FIG. 28, the inner surface of the endless belt rides against the belt-support lip, and each lateral edge of the belt sits adjacent to an annular retainment surface. This lipped end plate configuration provides some advantages. For example, since the inner surface of the endless belt rests on the belt-support lip, the material being baled is potentially more fully contained within the baling chamber formed by the inner surface of the endless belt and the inner surface of the lipped end plate.

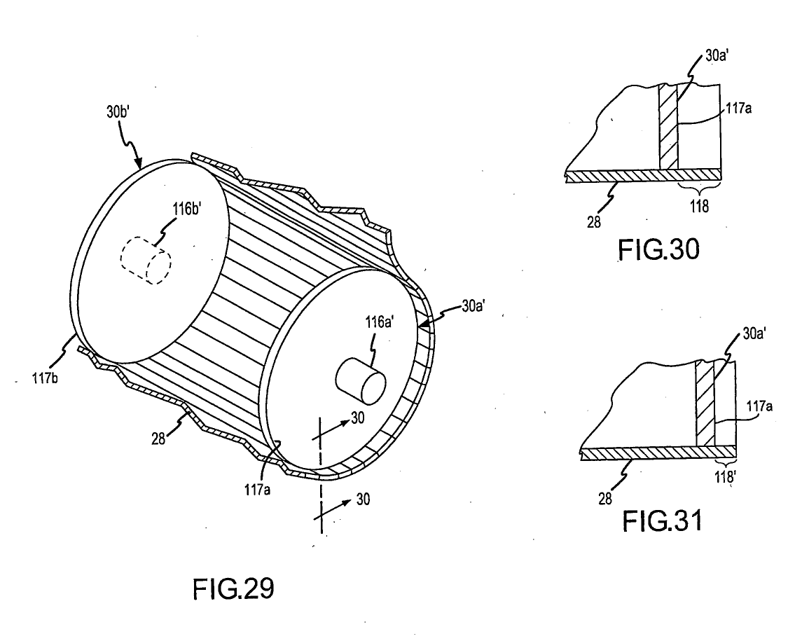

Under high compression, the endless belt may experience a negative moment, causing the belt to bulge in the direction of the arrow shown at the top of FIG. 28. As the pressure being applied to the material increases, this bulge can also increase. Of course, as the “belt bulge” increases, and assuming the position of the end plate is fixed for the moment, each belt lateral edge may be displaced toward the lip inner edge (see FIG. 28). Under certain circumstances, the stresses on the belt may continue to increase, and the belt lateral edges may eventually retract past the lip inner edge, no longer riding on the belt-support lip or ledge at all. Since the overall end plate thickness may be on the order of two inches, it is important to consider other possible end plate configurations for high compression environments. For example, the belt-support lip may be made wider. FIGS. 29-31, which will be described more fully below, describe an alternative solution that works for certain applications. In FIG. 28, each end plate is also connected to an end plate displacement ram. Thus, if excessive belt bulge were to occur, the end plate displacement ram at each end of the bale could be activated to move the longitudinal end plates closer together until the bulge subsided.

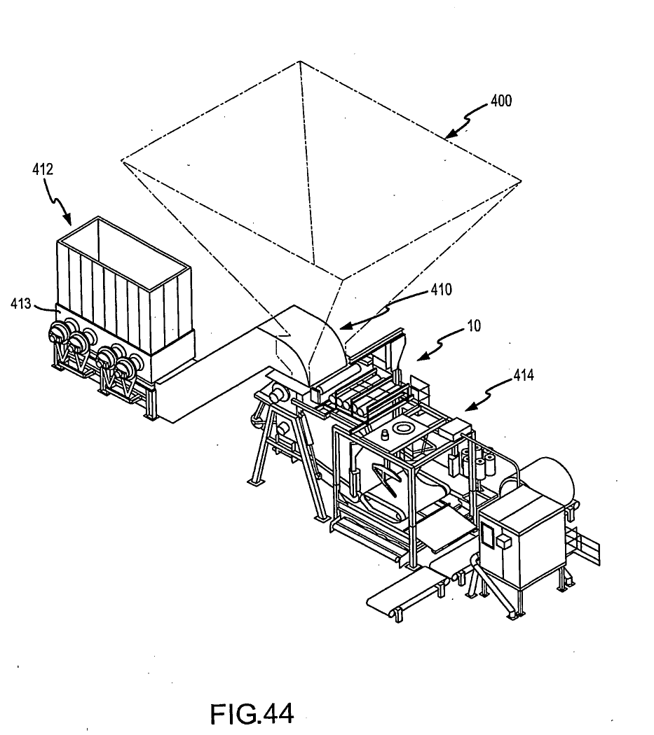

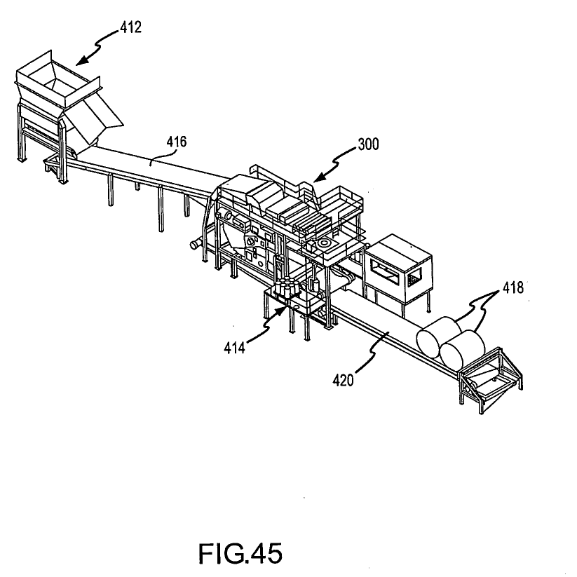

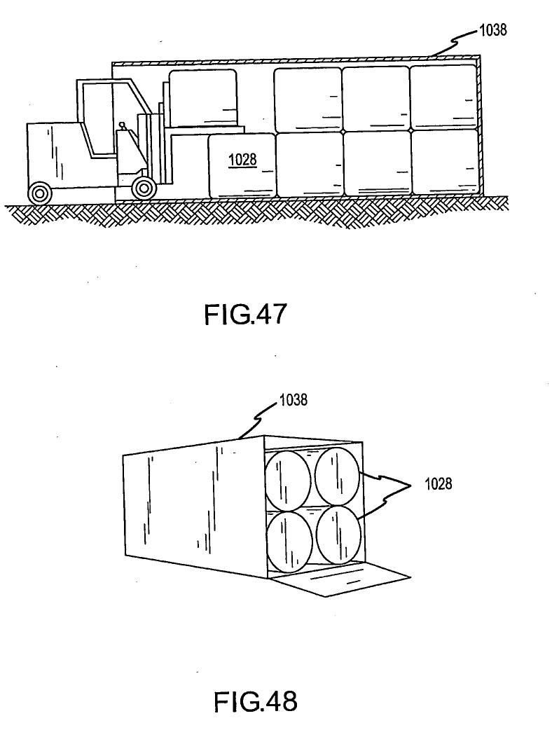

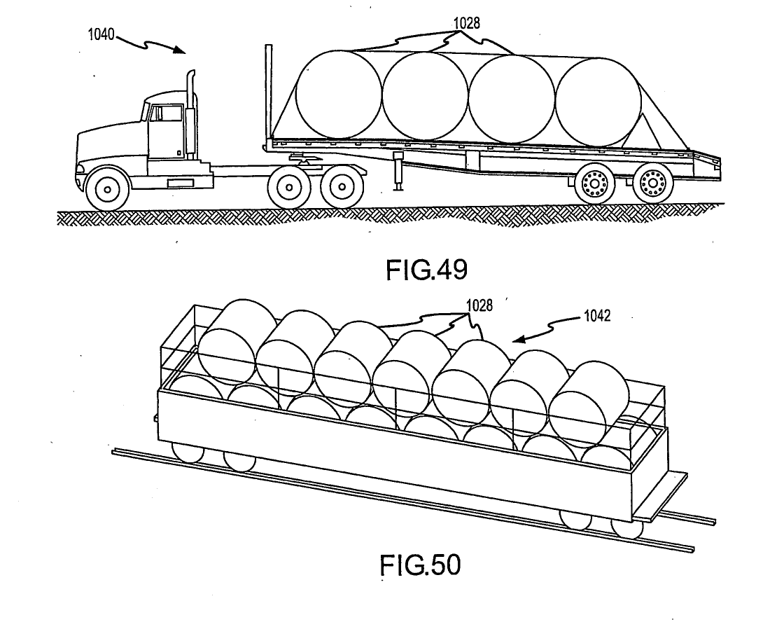

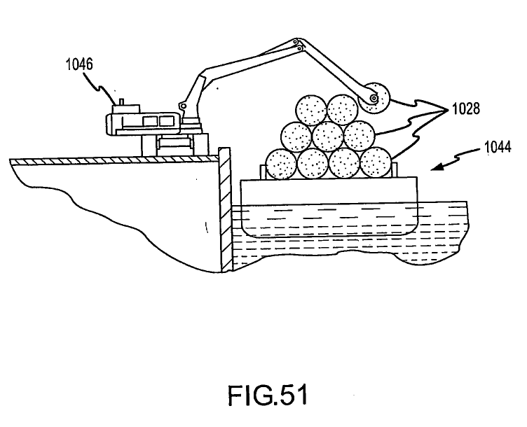

Even if the endless compression belt is not bulging, it may be desirable to adjust the overall length of the bales by selectively activating these rams via instrumentation in the baler control room (see FIGS. 44 and 45). Being able to adjust the ultimate length of the bales on the fly, makes it possible to, for example, ensure that the length of the bales maximize the available space in a shipping container (see, e.g., FIGS. 47 and 48) or to ensure that the bales fit snuggly in a railcar (see, e.g., FIG. 50) or other transportation means (see, e.g., FIGS. 49 and 51).

FIGS. 29-31 show an alternative configuration for the baling chamber itself. In particular, the end plates shown in these figures are “lipless” end plates. In this configuration, the lateral edges of the endless compression belt extend past the end plate outer surface, creating the portion (e.g., 3-4 inches) of the endless belt that extends beyond the end plate that is clearly visible in FIG. 30. Then, if the belt bulges or flexes under high compression in the direction of the bulge deflection arrow shown in FIG. 29, the lateral edges of belt are pulled inwardly, as shown by comparing FIGS. 30 and 31. For particular situations, the lipless end plates can be advantageous because they permit belt extensive bulging without detrimental effects and unnecessarily thick end plates. Again, an end plate displacement mechanism is shown in FIG. 29 associated with each end plate to provide the ability to control the length of the bales for specific applications where a difference of a few inches in longitudinal length of a bale provides advantages.

FIGS. 32-34 depict details for an optional sprayer assembly. It may be desirable, for example, to spray the material to be baled as it enters the baler. For example, it may be desirable to spray a small amount of water on the material to control dust, or it may be desirable to spray additives, or odor control additives, or disinfectant additives, or stabilizing compounds, or any other additives on the material entering the baler. In FIG. 32, the sprayer assembly is shown exploded away from the baler. Four mounting brackets are depicted on the baler body to receive and support the sprayer assembly. FIG. 33 is a cross-sectional view taken along line 33-33 of FIG. 32. In FIG. 32, an individual sprayer is shown protected between a back plate and a cover plate depending upon the particular situation, these plates may be constructed from, for example, sheet metal or ¼ or ½ inch thick steel plate.

The back plate and the cover plate are clearly visible in FIG. 34. As shown to best advantage in FIGS. 33 and 34, each of the sprayers includes a sprayer tube and a sprayer head or nozzle. The nozzle is at the distal end of each sprayer tube, and the proximal end of each sprayer tube is connected to a distribution manifold. The back plate comprises a plurality of sprayer tube slots that are present to accommodate sprayer tubes when the back plate is affixed to the cover plate. FIG. 25 is a schematic view one embodiment of a baler in operation with the sprayer functioning. In particular, a stream of materials to be baled is schematically depicted by the fat arrow pointing into the throat of the baler. The additives being applied to the material as it enters the baler are represented by the three smaller arrows adjacent to the lower edge of the sprayer assembly.

FIGS. 36A, 36B, 36C, 37A, 37B, 37C, 38A, and 38B are schematic representations of the process of off loading precursor bales produced by different balers. FIGS. 36A, 36B, and 36C depict a prior art tailgate in a fully-down or fully-open position. The tailgate slope angle is relatively shallow (e.g., approximately 5.98°) even though the tailgate is depicted in its fully-open configuration. In FIG. 36A, the tailgate has just reached its fully-opened position. At this point, the slack in the endless compression belt creates a trough between the two depicted rollers caused by the weight of the bale (e.g., 8 U.S. tons). Once the bale settles in this trough in the prior art system where the tailgate slope angle is relatively shallow, it can be difficult and hard on the equipment to get the bale off of the tailgate. In particular, the tension in the belt may need to be dramatically increased in order to counter the weight of the bale and to start to lift the bale in the direction of the baler lift direction arrow as shown in FIG. 36B. Comparing the tension in FIG. 36B to the tension in FIG. 36C, it is apparent that even further increases in belt tension have to be generated in order to fully support the weight of the bale (i.e., to lift the bale sufficiently out of the trough formed by the previously existing slack in the endless compression belt). In addition to increasing the tension in the belt to the highest point it reaches during the entire baling process, once the bale is lifted sufficiently out of the trough as shown in FIG. 36C, the belt direction may need to be reversed from the direction that it was moving during the bale formation, in order to move the bale off of the end of the tailgate. Thus, this prior embodiment required both tremendous belt tensions and reversing the motors in order to unload each bale. Such high belt tensions can limit the life of the belt, and the need to fully reverse the direction of the belt undesirably increases the total processing time required to create and unload the bale.

FIGS. 37A, 37B, and 37C depict a new embodiment that addresses some of these concerns. The embodiment depicted in FIGS. 9 and 10 is most similar to what is represented schematically in FIGS. 37A, 37B, and 37C. As may be observed from comparing FIGS. 36A to 37A, the tailgate slope angle, when the tailgate is in the bale-delivery position, has been increased. In one embodiment of the improved mechanism, the tailgate is lowered an additional 6°, from 5.98° to 11.98° below the horizontal. This relatively steep tailgate slope angle was not used in the prior art because of concerns that the bale would roll off of the distal end of the tailgate prematurely. In FIG. 37A, the tailgate has just initially reached its fully-opened configuration. Again, the slack in the belt has permitted the formation of a trough in which the bale rests in FIG. 37A. Since the tailgate is at a steeper angle, however, less belt tension is required to lift the precursor bale out of its trough. Further, also in view of the relatively steeper tailgate slope angle in the depicted bale-delivery position, the bale tends to naturally roll off the distal edge of the tailgate as soon as sufficient belt tension has been applied to lift the bale out of the trough. As represented by the dashed arrow in the bottom of FIG. 37C, it is still an option to run the endless compression belt in the opposite direction if necessary (e.g., if the bale hangs up on the compression roller). The tailgate slope angle depicted in FIG. 37A has been determined through empirical studies to establish a tailgate slope angle that “motivates” the bale to leave the tailgate, without sending the bale rocketing off the end of the tailgate prematurely. Also, control system improvements have made it possible to more carefully control the specific position of the tailgate making it possible to implement the steeper sloped configuration.

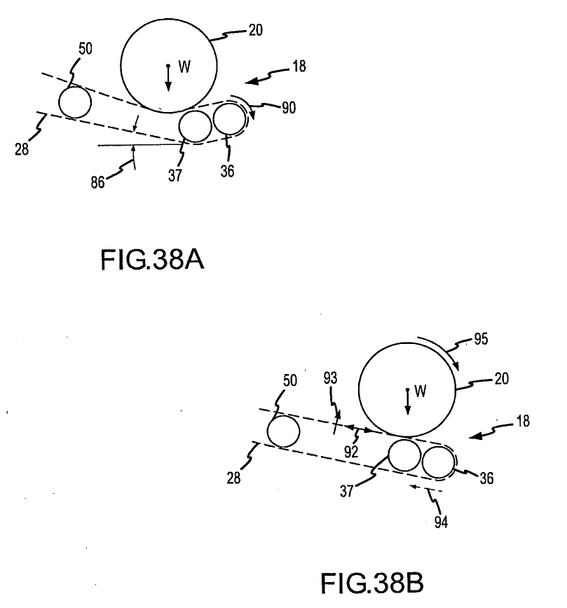

FIGS. 38A and 38B essentially depict the embodiment of the baler that is also shown in FIGS. 1-8. As mentioned above in connection with FIGS. 7 and 8, this configuration of the baler comprises a tilt roller pair. The tilt roller pair can be used to contain the bale on the distal portion of the tailgate until it is time to move the bale off of the tailgate. In particular, as shown in FIG. 38A, the tilt roller pair is tilted upward and thereby stops the bale exiting the baling chamber from rolling off the distal edge of the tailgate. Once the bale is stabilized in the position shown in FIG. 38A, the tilt roller pair can be rotated the opposite direction (see the curved arrow near the distal edge of the tailgate in FIG. 38A) so that the bale may roll off the end of the tailgate to the awaiting transfer belt or wrapping table (show in FIG. 8). If necessary, the belt tension may be increased (see, the double-headed arrow in FIG. 38B) to lift the belt in the direction of the single-headed arrow pointing upwardly in FIG. 38B to help roll the bale off of the tailgate.

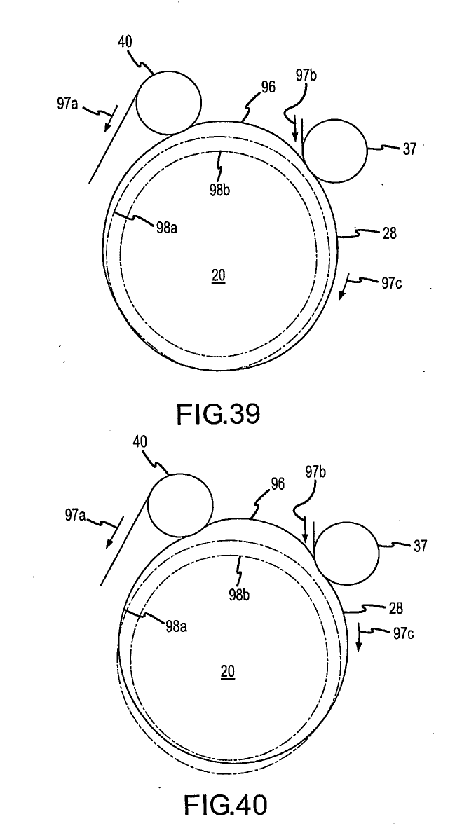

Each of FIGS. 39-42 is a graphical depiction of the results of a computer simulation. For each of these figures, the same starting parameters were used (e.g., the same amount of material was assumed to be in the baler chamber, and the material was assumed to have exactly the same properties for each of the four simulations). FIGS. 39-42 depict the bulge that forms when the tension on the endless compression belt is increased. In FIGS. 39-42, the endless belt is traveling in the direction of the three arrows appearing in each of the four figures. In FIGS. 39-41, the baler is assumed to be operating in the configuration depicted in, for example, FIGS. 3 and 4. In other words, the distal tilt roller of the tilt roller pair is not shown in FIGS. 39-41, but would be directly above the proximal tilt roller, which is shown in these three figures and which is acting as the compression roller. In FIG. 41, the baler is assumed to be operating in the configuration depicted in, for example, FIG. 6. There are two concentric dashed rings also depicted in each of FIGS. 39-42. The outer dashed ring represents the outer circumference of a large baler end plate, and the inner dash ring represents the outer circumference of a smaller baler end plate.

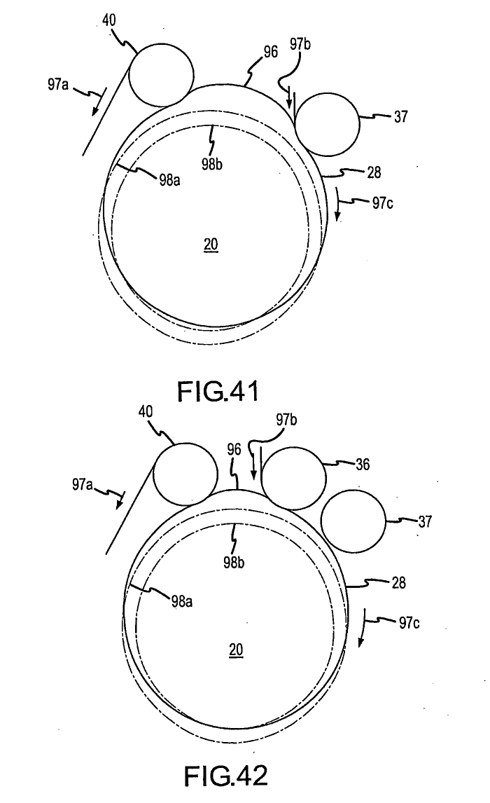

In FIG. 39, the endless belt tension was simulated to be at a first, relatively low tension. For FIG. 40, the baler was assumed to have the same configuration that it had for the simulation of FIG. 39, but the belt tension was simulated to be at a higher tension than for the FIG. 39 simulation. In FIG. 41, the baler was again assumed to have the same configuration as the baler used for the simulations of FIGS. 39 and 40, but the belt tension used in the simulation that generated the drawing of FIG. 41 was assumed to be higher than the belt tension used for the simulations that resulted in FIGS. 39 and 40. For FIG. 42, the belt tension is assumed to be the same as the belt tension of FIG. 41. In the FIG. 42 simulation, as mentioned above, the distal tilt roller has been rotated toward the baling chamber and into contact with the outer surface of the bale, so it is acting as the compression roller. In FIG. 42, the proximal tilt roller is no longer acting as the compression roller as it was for the simulations depicted in FIGS. 39-41. Thus, in FIG. 42, the gap between the drive roller and the effective compression roller has been reduced.

Referring back to FIG. 39, at this relatively low simulated belt pressure, a small bulge has started to form in the gap between the drive roller and the compression roller (i.e., the proximal tilt roller). Further, as shown in FIG. 39, the compression forces being placed upon the material that is being baled could be applied with a large end plate in place, which is evident since the belt is shown at the lower portion of FIG. 39 as tracking closely with the outer dashed ring. In FIG. 40, the simulated belt tension is relatively higher than the belt tension used for FIG. 39. Under this higher belt tension, the bulge has increased in size. Also, it is evident from FIG. 40 that, in order to achieve this higher compression of the material that is being baled, it would be necessary to have the smaller bale chamber end plates in place. This is evident since the endless belt is depicted as traveling inside the outer dashed ring, which represents the outer circumference of the larger bale chamber end plate. Thus, it is evident from FIG. 40 that in order to achieve these simulated compressions of the material in the bale chamber, a smaller bale chamber end plate is required.

One way of looking at FIGS. 39-42 is to think of the compression roller as a tire that is trying to drive over the bulge forming in the gap between the compression roller and the drive roller. Using this analogy, it is clear that the “tire” (i.e., the compression roller) could more easily “drive over” the bulge depicted in FIG. 39 than the bulge depicted in FIG. 40.

In FIG. 41, the belt tension has been increased again. This time the belt pressure is greater than the simulated belt pressure used for the simulation depicted in FIGS. 39 and 40. In FIG. 41, the bulge has become unmanageable (i.e., the “tire” can no longer drive over the bulge). Thus, when the compression reaches the level used for the simulation that resulted in the drawing of FIG. 41, the baler motors would stall and/or the bale would burst at the bulge and require a baler shutdown. Also, since the endless belt is now shown as traveling within both dashed rings, this makes it clear, if not additional material is added to the bale, that an even smaller end plate is required (or one of the existing end plates must be shifted up and to the right), or the depicted compression cannot be achieved.

To create FIG. 42, the simulation was run at the same belt tension used for the FIG. 41 simulation. In FIG. 42, however, the distal tilt roller was rotated toward the baling chamber and into contact with the outer surface of the bale that is being formed. Thus, with the distal tilt roller brought into play, it becomes the compression roller, and the proximal tilt roller, which had been acting as the compression roller in the simulations of FIGS. 39-41, is no longer acting as the compression roller. Keeping in mind that the belt tension used in the simulation that created FIG. 42 is the same as the belt tension used in the simulation that created FIG. 41, some interesting things can be seen. First, the bulge is now manageable again. That is, the “tire” (i.e., the distal tilt roller) is able to “drive over” the bulge. Further, the endless belt is now remaining outside of the smaller dashed circle. Thus, with the tilt roller pair in place and positioned as shown in FIG. 42, a never before achievable compression ratio is now possible as long as the smaller bale chamber end plate is used and the tilt roller pair is positioned as shown. In essence, the gap size between the drive roller and the compression roller limits the maximum density achievable for a given amount of a given type of material. Thus, the baler depicted to best advantage in FIGS. 2-8 is able to achieve previously unattainable compression levels without stalling the drive motors (i.e., higher bale densities using less power). When the tilt roller pair is positioned as shown in FIG. 42, not only is the bulge in the gap controlled, but also the capture angle is improved, delivering more frictional force to the waste being introduced in the gap between the drive roller and the compression roller, making it possible to ingest additional material into the bale that is being formed. Since the tilt roller pair is adjustable, it is possible to open the throat until the smaller gap becomes necessary for “bulge control.”

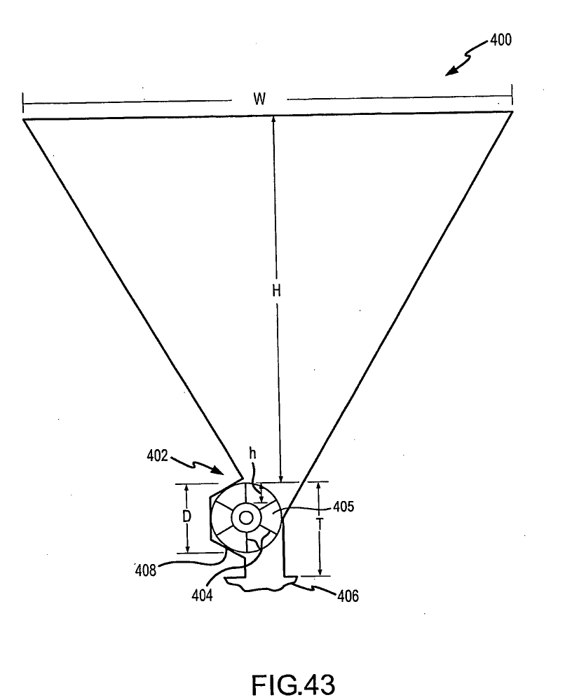

FIG. 43 depicts a sample super-charging hopper that may be used in combination with any of the balers disclosed herein. In one preferred form of this super charging hopper, the width, W, is approximately 34 feet, and the height, H, is approximately 26 feet. Further, in this one preferred embodiment of the super-charging hopper, the vein feeder includes feeder veins having a height, h, of approximately 1½ feet. The vein feeder has an overall diameter, D, of 5 feet. Further, in this one preferred configuration, the distance from the top of the baler to the top of the vein feeder, T, is approximately 7 feet. Material to be baled (e.g., shredded municipal solid waste) can be dumped into the super-charging hopper.

The vein feeder depicted in FIG. 43 comprises six metered chambers that deliver the material in the super-charging hopper to the delivery chute, which feeds directly into the entry path or throat (see, e.g., FIGS. 3-5) of the baler. As shown in FIG. 43, the left portion of the vein feeder is protected by a shield that prevents material in the super charging hopper from being delivered to the empty metered chambers on the left side of the vein feeder (since the vein feeder turns clockwise as shown by the arrow indicating the direction of rotation, the fact that these upward-traveling, metered chambers are empty means that the vein feeder motor requires less force to deliver material from the super-charging hopper to the delivery chute and ultimately to the throat of the baler). The vein feeder may turn at, for example, 15 RPMs.

FIG. 44 is an isometric view of one embodiment of a system incorporating the baler depicted in FIG. 1. As shown in FIG. 44, the system includes a closed chute to deliver material to be baled from, for example, a hopper or shredder. The material to be baled alternately may be delivered by a super-charging hopper, or the open belt depicted in, for example, FIG. 45 may be used to deliver material to be baled to the baler. As shown in FIG. 44, the baler may be followed by a wrapping station that completely encapsulates the precursor bale, thereby creating a hermetically sealed bale for subsequent disposition.

FIG. 45 is similar to FIG. 44, but depicts one possible system incorporating the baler of, for example, FIG. 11 with other components. In FIG. 45, the material from the hopper is delivered on an open belt to the baler. The bales are then delivered to a wrapping station that incorporates, for example, a heli-wrapper. The encapsulated (e.g., hermetically sealed) bales are then moved by another conveyor to a location where they can be off-loaded.

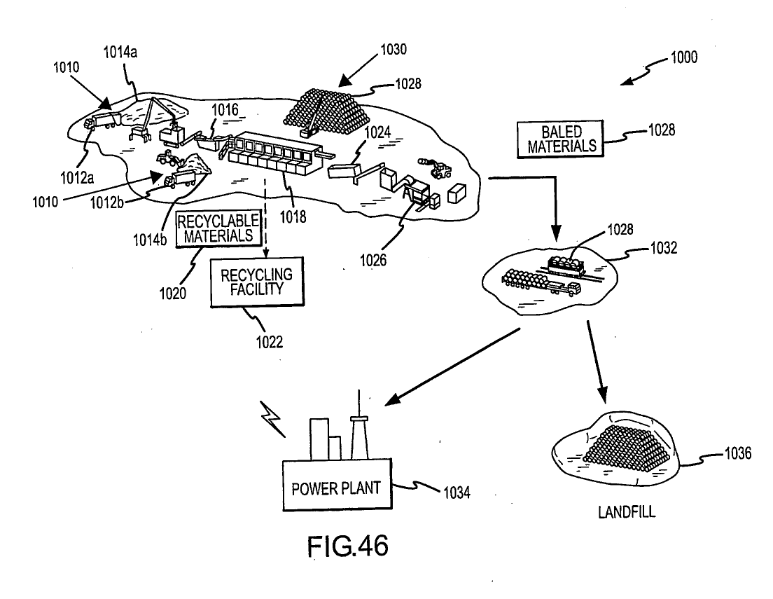

FIG. 46 shows one possible overall system for using the balers according to the present invention. In the upper left-hand portion of FIG. 46, a couple of tipping stations are shown where trash hauling trucks have dumped their loads, creating piles of unbaled waste or other material to be baled. As shown in this figure, this loose material is then loaded into a hopper or shredder. From the hopper or shredder, it may be delivered to a sorting facility to extract recyclable materials for subsequent delivery to a recycling facility. Once the material that is to be baled has been sorted from the recyclable material, a secondary hopper may be used to ultimately deliver the material to be baled to the baler, which is shown at the right side of the upper bubble in FIG. 46. As shown, the completed bales may be temporarily placed in a pile until they can be moved by, for example, rail, truck, barge, or container as shown in FIG. 46 to, for example, a landfill or a power plant.

FIGS. 47 and 48 depict a shipping container that may be used to move bales from where they are baled to another location. Since the bales may be hermetically sealed, the shipping container does not necessarily need to be a dedicated container that is used only to move waste, for example. FIG. 49 depicts four bales on a truck, and FIG. 50 depicts fifteen bales on a railcar. Similarly, FIG. 51 depicts nine bales on a barge and a tenth bale being loaded onto the barge by a bale handler. Using the balers according to the present invention, bale size and weight may be customized for a particular situation. For example, using the balers described above, bales may be customized in both length and weight to fit perfectly within the shipping container depicted in FIGS. 47 and 48, while maximizing the weight carrying capacity of that container. Similarly, the balers described above may be readily configured to provide the four bales shown in FIG. 49 in a dimension that fits the truck and a weight that maximizes its weight carrying capability. The same holds true for the railcar of FIG. 50 and the barge of FIG. 51. For example, if the railcar depicted in FIG. 50 can hold fifteen bales and carry one hundred five tons, the balers described above can be configured to produce bales that weigh seven tons each and that are dimensioned to fit snuggly within the railcar, thereby filling the railcar in every sense of the word.

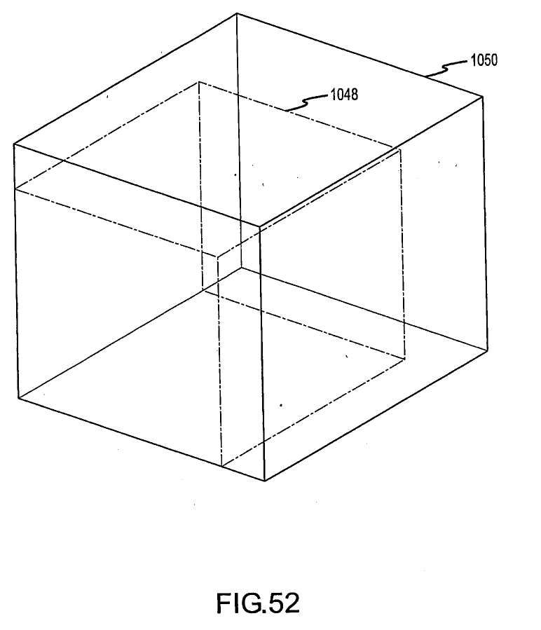

Using the balers described above in certain scenarios, it is possible to, for example, fit the same amount of municipal solid waste in 55% of the volume that would otherwise be required to handle that waste in a landfill where the waste was being delivered to the landfill in an unbaled state. FIG. 52 graphically depicts the volume savings. In particular, the dashed box within the larger box that is in solid-lines is shown as taking up 55% of the volume of the large box. Even before taking into account settling and compression resulting from overburden, much more efficient use may be made of the volume available in various landfills.

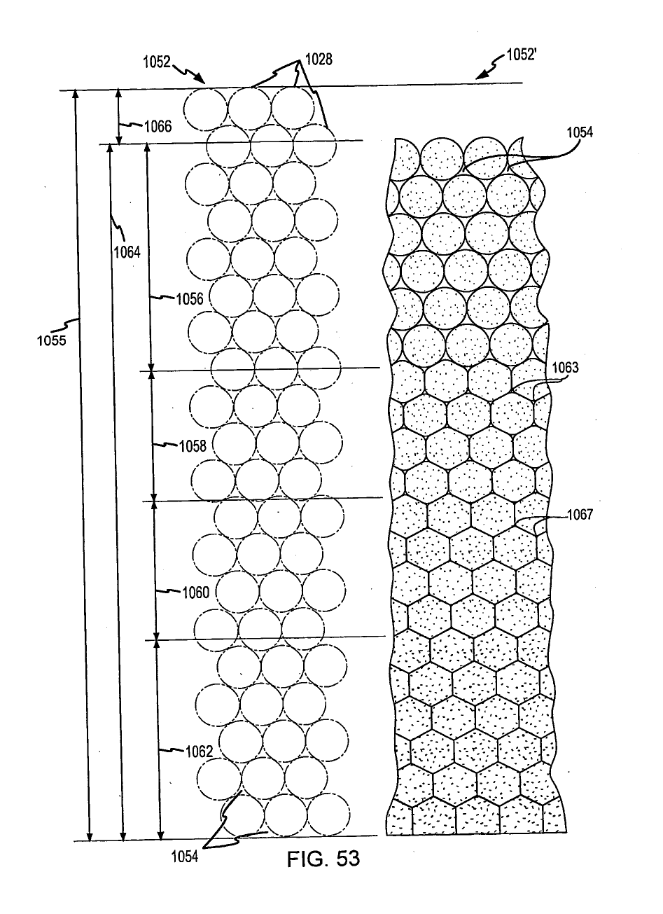

FIG. 53 graphically represents additional long-term gain in landfill volume savings that may be achieved using the balers described above. On the left side of FIG. 53, in phantom, are twenty rows of bales stacked one on top of another. Since the bales are cylindrical, initially there may be air gaps present in the stack of bales. In particular, for certain applications and bale sizes, the air gaps can account for approximately 10.27% of the total volume used. Over time, however, and due to the pressure placed on bales that are deeper in a landfill by the bales stacked on top of them (i.e., due to the overburden), the air gaps between adjacent bales tend to decrease over time. This is graphically represented by the bales on the right-hand portion of FIG. 53. In this portion of FIG. 53, the top six rows are depicted with the original air gaps comprising 10.27% of the total volume. The next five rows depict the bales with air gaps comprising only 3.52% of the total volume. The next four rows depict bales with air gaps comprising only 0.88% of the total volume. And, the final six rows demonstrate that, with sufficient time and pressure, the cylindrical bales eventually settle into all of the air gaps resulting in no air gaps between adjacent bales. The additional savings in landfill volume, for example, is represented by the vertically-oriented, two headed arrow at the top of FIG. 53.

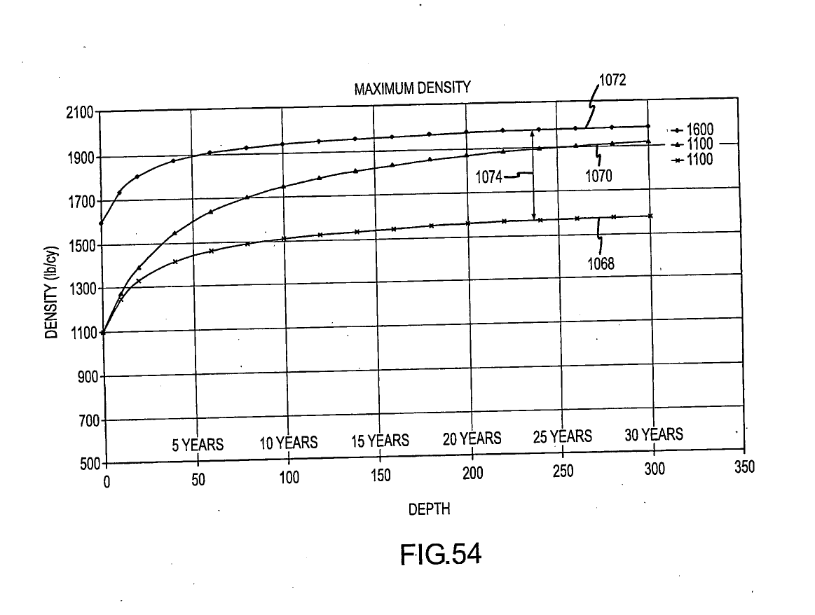

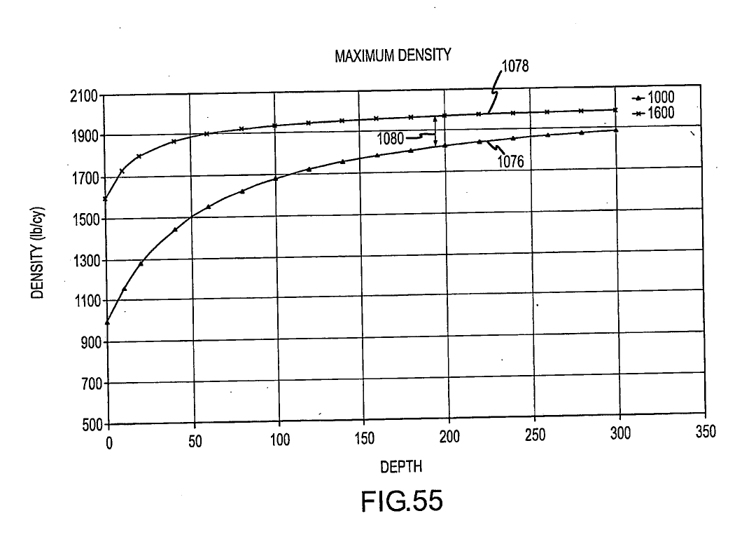

FIGS. 54 and 55 depict in another way the savings that may be achieved through use of the balers described above when the bales are being placed in landfills. In particular, looking at FIG. 54, three different curves are presented. The lowest curve (formed through a series of asterisks) represents densities achieved over time and depth of consolidated loose municipal solid waste (MSW) with initial density at 1100 lbs. per cubic yard and realistic compaction conditions taken into account. Thus, the left end of this line (labeled as line 1 in FIG. 54) starts at the surface at 1100 lbs. per cubic yard. 1100 lbs. per cubic yard is thought by some to be an attainable compaction for this type of waste when it is driven over and compacted by typical landfill surface-working equipment. The right end of this first line asymptotically approaches 1600 lbs. per cubic yard at a landfill depth of approximately 300 feet after thirty years.

The intermediate line on FIG. 54, which passes through a series of triangles, represents the density of consolidated MSW with the initial density at 1100 lbs. per cubic yard (like line 1), but with ideal shredding and compaction. Again, the left end of this intermediate line shows that it starts at 1100 lbs. per cubic yard at the surface of the landfill. This initial density for the MSW is again thought by some to be achievable by the surface-working equipment at the landfill driving over the MSW. In this case, assuming ideal shredding and compaction, at 300 feet depth in the landfill after thirty years, the MSW asymptotically approaching a density of 1900 lbs. per cubic yard.

Using the balers of the present invention, it is possible to compact the MSW to approximately 1600 lbs. per cubic yard in the baler. Thus, the top line in FIG. 54 starts at its left-hand end at 1600 lbs. per cubic yard at the surface. This particular line, which is labeled 3 and which passes through a series of circles represents the density of a “balefill” (i.e., a landfill in which only bales have been placed rather than loose MSW) with initial bale densities at 1600 lbs. per cubic yard. Under these circumstances, the bales in the balefill at a depth of 300 feet after thirty years would be expected to asymptotically approach a density of approximately 2000 lbs. per cubic yard.

The vertical distance between the different lines depicted on FIG. 54 are proportional to the amount of landfill volume used under each scenario. Thus, for example, the vertical gap between line 1 and line 3 clearly shows that a substantial volume in the landfill will be conserved if a balefill is used rather than a conventional MSW landfill.

FIG. 55 is similar to FIG. 54. Since 1000 lbs. per cubic yard is thought by many to be a more realistic estimate of the surface compaction for loose municipal solid waste, line 1 on the FIG. 55, which passes through a series of small triangles, is drawn as starting at 1000 lbs. per cubic yard at the surface and becoming asymptotically approaches 1900 lbs: per cubic yard at a landfill depth of approximately 300 feet. The upper line in FIG. 55, which passes through a series of small asterisks and which is labeled line 2 in FIG. 55, is similar to line 3 in FIG. 54 and again represents density of a balefill with initial bale densities at 1600 lbs. per cubic yard. Again, at approximately 300 feet of depth in the landfill, the density of the balefill asymptotically approaches approximately 2000 lbs. per cubic yard. As previously discussed, the vertical distance between these lines is directly proportional to the volume of landfill saved by starting with the high compression bales that are producible using the balers described above.

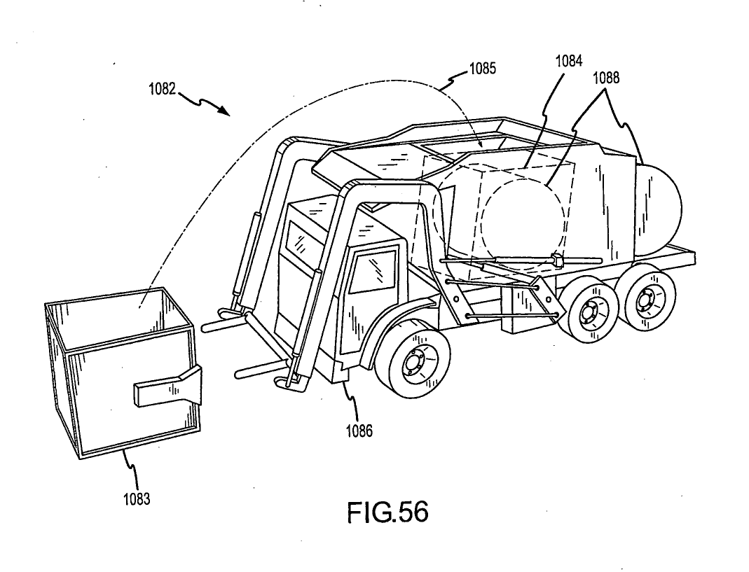

FIG. 56 is an isometric view of an embodiment of the present invention wherein a baler is mounted on a mobile trash truck. As depicted, this mobile baler would dump trash from, for example, dumpsters or other curbside pick up receptacles directly into the throat of the baler. While the mobile baler was parked or moving to its next pickup, baler could work on compressing the deposited materials. Once a fill bale was produced, it could be wrapped and then stored on the back of the truck until it was time for a trip to the landfill. As shown in FIG. 56, one finished bale is being carried on the back of the truck and a second bale is being formed in the baler. As soon as these two bales are complete, the truck could make a trip to the landfill to off-load the two complete bales.

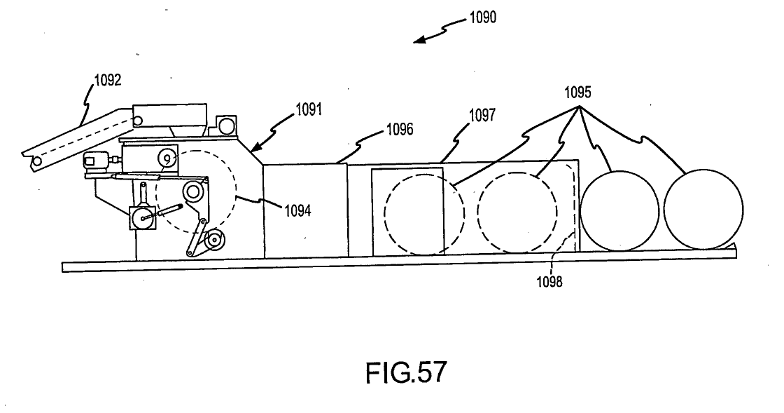

FIG. 57 depicts another application for the balers described above. Frequently, large trash compactors may be found installed at large office facilities, restaurants, or hotels that produce a high volume of waste. One of the balers described above could be used in place of these trash compactors. As shown in FIG. 57, trash could be input, possibly by a conveyor, into the top of the baler. The baler would then be activated (possibly automatically) and would eventually form a bale. The bale would be delivered from the baler to a bale wrapper, which is indicated in FIG. 57 to be in the box behind the baler for simplification. The bale wrapper is depicted in more detail in, for examples, FIGS. 44 and 45. Completed and wrapped (e.g., hermetically sealed) bales could then be stored internally and/or externally at the site. In FIG. 57, two complete, hermetically sealed bales are shown contained within the housing of the baler system to prevent tampering. Also shown in FIG. 57 is an optional door that could completely seal the baler system from unauthorized access. Thus, as trash is dumped into the baler, it could be automatically activated to generate a bale that would then be wrapped and subsequently stored all within a closed compartment. When a pickup was necessary, the optional door, if present, would be opened by someone authorized to haul off the bales, allowing the bales to move to a pickup station where they could be moved onto a transport of some kind (e.g., a truck) and taken to, for example, a landfill. Since the baled densities and compaction ratios achieved by the balers described above are greater than the densities achievable by conventional compactors, fewer trips to the site would be required by the trash removal service to remove bales than would otherwise be required to remove the compacted trash coming from a conventional trash compactor.

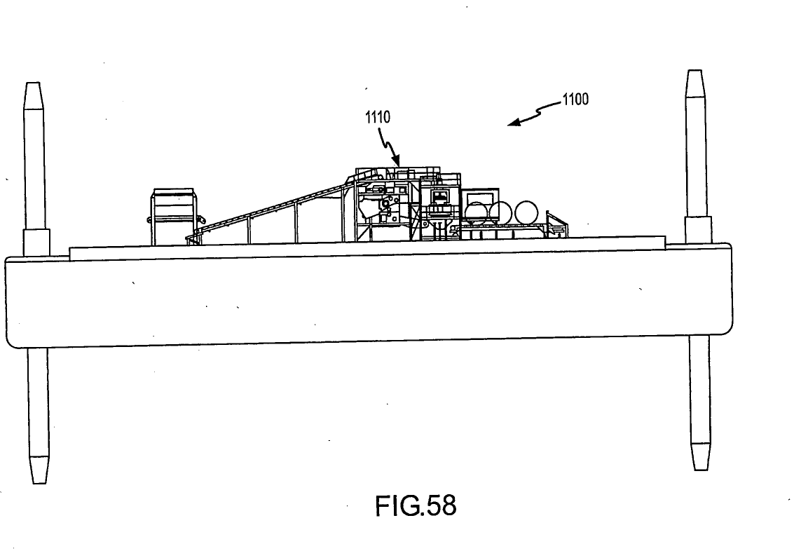

FIG. 58 shows another application for the baler described above. In particular, as shown in FIG. 58, a baling system comprising one of the balers described above can be mounted on a barge, with or without spuds. By mounting the baling system on a barge, it is easily relocatable whenever necessary or desirable. Also, the barge can be configured to contain any contaminates or leachate that may be produced or result from the baling process.

Although embodiments of this invention have been described above with a certain degree of particularity, those skilled in the art could make numerous alterations to the disclosed embodiments without departing from the spirit or scope of this invention. All directional references (e.g., upper, lower, upward, downward, left, right, leftward, rightward, top, bottom, above, below, vertical, horizontal, clockwise, and counterclockwise) are only used for identification purposes to aid the reader's understanding of the present invention, and do not create limitations, particularly as to the position, orientation, or use of the invention. Joinder references (e.g., attached, coupled, connected, and the like) are to be construed broadly and may include intermediate members between a connection of elements and relative movement between elements. As such, joinder references do not necessarily infer that two elements are directly connected and in fixed relation to each other. It is intended that all matter contained in the above description or shown in the accompanying drawings shall be interpreted as illustrative only and not limiting. Changes in detail or structure may be made without departing from the spirit of the invention as defined in the appended claims.

### Supplemental Material

1. Goal I: Increase bale density
a. Control system
   i. Old: when the bale reached a certain size, the bale was deemed “complete” (bale-size-controlled system)
   ii. New—“pulsing system” that applies multiple compression cycles and which is much more adaptable/controllable/configurable
      1. Compression roller is always running, which drives the compression belt—the belt tension is increased to increase the compression forces acting on the material being baled
         a. The bale in the compression chamber is rotated at 10 to 40 RPM
         b. The compression roller thus works on a small area of the bale 10-40 times per minute rather than trying to squeeze the entire bale with the same amount of force being applied to the small location
      2. Control “keys off of” both bale size and compression motor torque
      3. Essentially the process proceeds as follows:
         a. Waste is fed into the compression chamber
         b. Waste feeding is paused for a manually-selectable or automatically-selectable period of time to accommodate full ingestion of incoming waste (this lag time needs to be minimized to keep the overall processing time to a minimum)
         c. Waste is compressed by activating compression roller to increase belt tension and reduce the overall size of the bale
         d. These three steps are repeated as necessary to achieve desired bale characteristics
      4. Adaptable—permits “flexible/selectable” parameters that can be “dialed in,” for example:
         a. As waste composition changes
         b. As target weight/density for the finished bales changes (e.g., 1400 lbs/cubic yd to 2000 lbs/cubic yd bale density) depending upon intended use of finished bale:
            i. Instant placement in a landfill
            ii. Shipping by truck, barge, railcar, etc.
            iii. Storage on the surface (temporary or permanent)
         c. To delay feeding of the bale securement netting (adjustable lag) to ensure ingestion of last inbound waste is complete—control is keyed off torque as indicated by the amperage on the motor
      5. Facilitates on-sight and off-sight tracking of bale/production data (traceability of bale, tipping weights, etc.)
      6. Capable of controlling multiple motors if employed (see below)
b. Structural changes to compression chamber end plates
   i. Smaller compression chamber end plates
      1. Due to expansion of the waste after pressure release during compression, need to compress bale smaller than size ultimately desired
      2. After considering mere increase in motor size, UTEX determined that merely pressing harder is insufficient (i.e., using a bigger motor is not always the answer)
      3. This change required close/tight tolerances on side swing plates (“guide plates”), which also hold the “netted bale” momentarily after compression chamber initially opens
   ii. Longitudinally-moveable end plates
      1. allows operator to “dial in” a bale length for a specific situation (e.g., to maximize the load in a container)
      2. one possibility is longitudinally-extending hydraulic rams to move the end plates towards and away from each other (one or both end plates being hydraulically mounted)
      3. in addition to setting bale length, the hydraulically-mounted end plates may also be used to increase compression of bale contents
         a. multi-modal compression system (e.g., both the belt squeezing and one or both end plates moving) or
         b. uni-modal compression system (e.g., the end plates providing most or all of the compression)—one drawback of the uni-modal system being speed—uni-modal stroke compression is slow
c. Add an additional roller (upper idler roller) adjacent to the compression or compaction roller
   i. improves compression chamber entry path configuration by changing the angle of the compression belt between the upper idler roller and the compression roller, which leads to more efficient ingestion of shredded waste
   ii. places the compression belt adjacent to the throat of the compression chamber at an angle designed to increase the “useful frictional force” on the waste being ingested, which more effectively pulls the individual elements comprising the waste stream into the compression chamber (i.e., to pull more shredded waste into the more-highly-compacted bale and inhibit “boiling or tumbling or bouncing” of waste and the formation of a “lump” between the rollers defining the entrance to the compression chamber)
   iii. additional idler roller may be tiltable or may be at a fixed position/angle
      2. Goal II: Reduce overall processing time for each bale
a. facilitate faster ingestion of shredded waste by inhibiting the formation of a standing wave in the throat of the input pathway, which otherwise leads to “feed rejection” or “jamming” and concomitant delays while waiting for the shredded waste to be incorporated into the bale being formed
   i. via improved compression chamber entry path configuration (noted above)
   ii. less time waiting for tumbling items to be incorporated into the bale
   iii. reduce the occurrence of machinery stalls caused when system “chokes on” a swell or lump that must be pulled past the compression roller
b. add an additional motor and separate control systems for each motor (for example, a motor for pressing and a separate motor for ingestion)
   i. Separate control systems allow diversion of power to the motor that needs it most
   ii. The ingestion motor may remain offline until the chamber starts to become full and ingestion starts to become more difficult
   iii. In the past, motor stalling was possible as compression increased—the single motor struggled to accomplish both tasks (compression and ingestion)
c. Inhibit lateral skewing of bale securement netting by forcing the netting to travel over a larger arc (rather than just the nip) of the cylindrical surface of the roller over which the netting is delivered, which gives the helical grooves on this netting-delivery roller more of an opportunity to scroll the netting's lateral edges outward on the netting-delivery roller
   i. Netting, which helps retain the bale in its compressed state until wrapping is completed, becomes more important as the bale density is increased (can even be used to “squeeze in” some bulges that would otherwise be on the outer surface of the finished bale)
   ii. Hydraulic motor for netting “brakes” to keep “turn tension” on bales
   iii. 7 ton bale takes 4-6 wraps to effectively hold the bale as it is transported to the heli-wrapper
   iv. Optimized to reduce the number of wraps—different bale densities require different minimum number of wraps to achieve adequate bale securement
      1. Reduces processing time for each bale
      2. Reduces netting cost for each bale
   v. If netting jams, delays are caused
   vi. If netting fails during bale dispatch to heli-wrapper, delays result
   vii. 48″ wide in some embodiments
d. Increase MTBF by reducing stress on the compression belt during bale dispatch/expulsion/bale lift-off position (i.e., delivery to the wrapping table)
   i. open tailgate further (lower it more) to permit gravity to help the bale roll out of the “tailgate trough or depression” that exists since, during bale formation, the tailgate forms part of the compression chamber inner wall and thus includes a trough or depression (i.e., a dished-out or curved section). This trough becomes part of the top surface of the open tailgate.
   ii. Sense using belt load sensors at lift-off point
   iii. Changing the angle of the “tailgate” portion
e. Minimize number of wraps of outer wrapping material around completed bale—number of wraps is optimized to give adequate support/security to reduce the number of bale ruptures during normal handling without overkill
f. Supercharge compression chamber
   i. Hopper of shredded material to “dump/release” into compression chamber on demand and in bulk—avoids unnecessary tumbling of the waste that occurs before sufficient waste is present that compression may begin. The compression chamber does not get smaller than a certain size and, thus, has no compression effect on the waste until sufficient delivery of waste into compression chamber has occurred
   ii. “End load” the compression chamber
   iii. can shave 10-15 seconds off the overall processing time

### 3. Goal III: Facilitate Easy Transportation of Finished Bales

a. Sealed sufficiently that can move by open railcar (e.g., gondola)
b. Stop aerobic decay/breakdown (oxygen depletion occurs quickly due to tight compression squeezing out air)
c. Stop anaerobic decay/breakdown (high density makes percolation harder)
d. Stop leachate (leaking controlled by outer wrapping)
   i. MSW has 10-15% moisture content on average (25-30% moisture in US)
   ii. At 35 psi, can squeeze out leachate and must deal with it in the apparatus
e. Stop production of methane gas (“balefill” v. landfill)

### 4. Prior Art

a. 4-5 tons per bale
b. 900-1200 lbs/cubic yd
c. 81.5 to 82 inches long
d. Looser compaction—heavy compression is not required when bale will eventually be burned as energy source
e. Lore suggests that standard landfill Caterpillar compaction is at 1000-1100 lbs/cubic yd
f. “Overburden” (dirt between layers of waste) wastes landfill space—1 foot of dirt per 6 feet of waste
g. RPP compaction does in 3 minutes what previously took 1000 days of settling time

### 5. Alternatives

a. Move end plates in and out
b. Lay the whole system on its side (i.e., end up gravity feeding waste in from end of bale)
c. Hydraulic (newer machines) v. electric motors
d. Use smaller motors and run them faster
e. Redundancy (2 motors)—maybe you bypass use of one of the motors until later in cycle—motors on the same of different shafts
f. Shrink-wrap “bag” around waste (may be “sun activated” polyester butylene)
g. Drive lower right-hand roller too
h. Incorporate belt slip prevention/mitigation means for higher belt tension
   i. Sprockets on roller, but such sprockets can tear up belts
   ii. Faceted roller (e.g., 15 sides on drive rollers), but they are complex to manufacture
   iii. Round, rubber-coated roller to increase friction driving the belt
i. Distributed belt tension
j. Spray bale
k. Dunk bale
l. Netting embedded in film—for more rapid processing when “fill seal” is not required (ends of the bales would not be covered), could eliminate heli-wrapper

What is claimed is:

1. A baler for compressing material into bales, the baler comprising
a cylindrical baling chamber configured to receive the material, the baling chamber formed by
a pair of end plates establishing opposite, longitudinal end faces of the baling chamber; and
a driven endless belt guided by a plurality of rollers, the endless belt extending adjacent to the end plates and establishing a cylindrical outer periphery of the baling chamber, wherein the plurality of rollers includes
a tilt roller pair including a distal tilt roller and a proximal tilt roller, wherein said distal tilt roller is adapted to pivot into and out of contact with the material in the baling chamber; and
a driven roller, where a material entry path into the baling chamber is formed between the tilt roller pair and the driven roller.

2. The baler of claim 1, wherein each end plate of said pair of end plates comprises a belt-support lip, and wherein the endless belt further comprises an inner surface that rides against at least one of the belt-support lips.

3. The baler of claim 1, wherein each end plate of said pair of end plates comprises a lipless end plates defining an outer circumferential surface, and wherein the endless belt further comprises an inner surface and lateral edges, and wherein said best inner surface rides against at least one of the end plates outer circumferential surfaces adjacent to at least one of the belt lateral edges.

4. The baler of claim 1, wherein the baler is adapted to form a precursor baler, wherein the baler further comprises a tailgate adapted to open to facilitate removal of the precursor bale from the baling chamber, and wherein the tilt roller pair is adapted to control movement of the precursor bale so that the precursor bale does not inadvertently roll off of the tailgate while unloading the precursor bale from the baler.

5. The baler of claim 1 further comprising a tensioner assembly operatively associated with the endless belt, the tensioner assembly being adapted to selectably adjust an amount of pressure being applied by the endless belt to the material in the baling chamber.

6. The baler of claim 1, wherein the baler is adapted to form a precursor baler, and wherein the baler further comprises a tailgate pivotably connected to a baler frame adjacent the baling chamber, the tailgate adapted to open and close to facilitate removal of the precursor bale from the baling chamber.

7. The baler of claim 6, wherein the tailgate is lowered in the range of about 10° to about 14° below a horizontal plane.

8. The baler of claim 6, wherein the tailgate further comprises a shaping plate with a contoured surface for forming a curved side wall of the precursor bale formed inside the baling chamber.

9. The baler of claim 1, wherein the baling chamber tumbles and presses the material, thereby forming a precursor bale while dispersing throughout the material any moisture contained within the material.

10. The baler of claim 1 further comprising a netting delivery system having at least one netting supply roller to dispense netting into the baling chamber for initial securement of the material.

11. The baler of claim 10, wherein the netting delivery system further comprises
a smooth netting roller having longitudinal ends and being rotatably mounted adjacent to a grooved netting roller for spreading the netting toward the longitudinal ends of the smooth netting roller; and
a pinch roller adjacent a driven roller and adapted to pull the netting off of the at least one netting supply roller and around both the smooth netting roller and the grooved netting roller for feeding the netting into the baling chamber.

12. The baler of claim 1 further comprising a sprayer assembly with at least one protected sprayer fluidly connected at a first end to a distribution manifold and at a second end to a sprayer nozzle, the sprayer assembly being positioned adjacent to the material entry path and being adapted to spray water or additives onto the material entering the baling chamber.

13. The baler of claim 1 further comprising a super-charging hopper for feeding the material into the baling chamber, the super-charging hopper including a vane feeder comprising a plurality of metered chambers for delivering the material in the super-charging hopper into the baling chamber.

14. A method for compressing material into bales comprising the steps of
driving an endless belt around at least a driven roller and a tilt roller pair;
receiving the material in a baling chamber through a throat formed between the driven roller and the tilt roller pair;
increasing pressure being applied by the endless belt to the material in the baling chamber; and
securing the material in the baling chamber with netting to form the bales.

15. The method of claim 14 further comprising tilting the tilt roller pair toward the driven roller to narrow the throat formed between the driven roller and the tilt roller pair to reduce boiling of the material entering the baling chamber.

16. The method of claim 15, wherein tilting the tilt roller pair delivers more frictional force from the endless belt to the material entering the baling chamber and draws more of the material into the baling chamber to increase bale density.

17. The method of claim 14, wherein increasing pressure is by changing a path length that the endless belt follows.

18. The method of claim 14 further comprising opening a tailgate to a relatively steep tailgate slope angle for unloading the bales from the baling chamber without having to reverse a direction of travel of the endless belt.

19. The method of claim 14 further comprising controlling movement of the bales formed in the bailing chamber so that the bales do not inadvertently roll off of the tailgate while unloading the bales.

20. A configurable baling system for producing bales with a variety of densities, lengths, and diameters, the configurable baling system comprising
chamber means for receiving material, the chamber means formed by
an adjustable end plate means for adjustably setting bale length; and
an adjustable belt means for establishing a periphery of the chamber means; and
means for securing the material before an unloading operation from the chamber means.

21. The configurable baling system of claim 20 further comprising means for controlling movement of the secured material during the unloading operation.

22. The configurable baling system of claim 20 further comprising means for reducing leachate from the material.

23. The configurable baling system of claim 20 further comprising means for feeding the material into the chamber means.

24. The configurable baling system of claim 20 further comprising a wrapping station for converting the precursor bale into an hermetically sealed bale.
